(19) United States
(12) Patent Application Publication
(10) Pub. No.: US 2007/0194052 A1
(43) Pub. Date: Aug. 23, 2007

(54) ERGONOMIC FLUID DISPENSER

(75) Inventors: Michael J. McMahon, Glenview, IL (US); Stanley Piotrowski, Glenview, IL (US); Steven Doehler, Cincinnati, OH (US); William Dunn, Glenview, IL (US); Donald VanErden, Glenview, IL (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: ILLINOIS TOOL WORKS, INC., Glenview, IL (US)

(21) Appl. No.: 11/672,588

(22) Filed: Feb. 8, 2007

Related U.S. Application Data
(63) Continuation-in-part of application No. 11/092,514, filed on Mar. 29, 2005.
(60) Provisional application No. 60/558,188, filed on Mar. 31, 2004.
(60) Provisional application No. 60/586,007, filed on Jul. 7, 2004.

(51) Int. Cl. B67D 5/64; B67D 5/06; A47G 19/14

(52) U.S. Cl. 222/175; 222/1; 222/527; 222/465.1

(57) ABSTRACT

An ergonomic fluid dispenser. The ergonomic fluid dispenser includes a fluid container, a dispensing assembly, an optional carton, and at least one ergonomic strap connected to the fluid container or the carton. The ergonomic fluid dispenser allows a user to remain standing during application of the fluid.

### CROSS REFERENCE TO RELATED APPLICATIONS

This application is a continuation-in-part of U.S. application Ser. No. 11/092,514, filed Mar. 29, 2005, entitled Ergonomic Fluid Dispenser, which claims the benefit of U.S. Provisional Application Ser. No. 60/558,188, filed Mar. 31, 2004, entitled “Ergonomic Fluid Dispenser,” and U.S. Provisional Application Ser. No. 60/586,007, filed Jul. 7, 2004, entitled “Ergonomic Fluid Dispenser.”

### BACKGROUND OF THE INVENTION

The present invention relates generally to a fluid dispenser, and more particularly to an ergonomically designed fluid dispenser that allows a user to remain standing during application.

Applying adhesive during construction to sub-floors, drywall, and other surfaces typically involves the use of a manual or pneumatic hand gun with a disposable adhesive cartridge. The disposable adhesive cartridges are usually made from spiral wound paper cores which may be reinforced circumferentially with metallized film, to help make them hermetic. The cartridges are sometimes made of plastic tube. There is a piston plate on the drive end of the cartridge, and a small nozzle on the other end. Both the piston plate and the nozzle are sealed to the cartridge tube, which is filled with adhesive. When the hand gun is operated, the nozzle is punctured. The piston plate is unsealed and advanced by a push rod on the dispenser. As the piston plate advances, pressure is applied to the adhesive causing it to flow out of the nozzle. The hand gun typically weighs about 2 lbs. as does the adhesive cartridge. This results in an adhesive to holder weight ratio of about 1 to 1.

However, this type of fluid dispenser has a number of limitations. The use of the external push rod to move the piston plate causes column compression loading, which can buckle the cartridge if the friction resistance or back pressure becomes excessive. The cartridge is typically about 2.5 inches in diameter and 12 inches long, and the capacity of the cartridge is generally limited to about 2 pounds because the length and diameter of the cartridge must be restricted so that the internal pressure does not cause the cartridge to swell or bend. As a result, the operator must stop frequently to replace the cartridge. The larger the geometry of the cartridge for a given pressure, the more ballooning of the cartridge tube will occur. Since the fit between the piston and cartridge must be tight without clearance in order to operate properly, any ballooning will cause the adhesive to leak back across the piston. The bleed back of adhesive causes malfunctioning of the cartridge and contaminates the push rod of the dispenser. The adhesive must then be cleaned off the dispenser. The tight fit between the piston and the cartridge tube also increases the piston friction, which requires more work to operate the push rod. The tight fit can also cause quality problems in manufacturing.

Moreover, because the operation of the cartridge depends on a dispenser with its associated hardware, the system is prone to damage as a result of improper handling during use or refilling.

Furthermore, the small nozzle is short. As a result, the operator must bend over, squat down, or kneel in order to apply the adhesive, particularly for sub-floors. These positions are not good ergonomically, and can lead to accumulated trauma disorders.

There is an extended version of the hand gun assembly, which has a handle extension, allowing use in an upright position. However, it is also subject to damage during use, and the operator must stop frequently to replace the adhesive cartridge. Although the extended hand gun improves the application posture, it is worse with respect to the ergonomics of the wrist, arm, and shoulder because of the increased torque that occurs when the 4 lbs. of gun and cartridge are on the opposite end of the extension for the hand gun.

The handgrip pull force is ergonomically challenging because the small nozzle causes backpressure force during dispensing. The manual operation of the hand gun can lead to carpal tunnel syndrome over time. Operators sometimes cut the nozzle off to decrease the backpressure, but the resulting increased flow rate requires the operator to apply the adhesive with a sweeping arm motion, which results in sloppy and variable application. Because of the difficult ergonomics, operators sometimes skip spots and under-apply the adhesive to minimize the effort.

Often, the operator is part of a three person work crew in constructing the sub-floor: the adhesive applicator, the panel mover, and the panel nailer. The application of adhesive is generally the limiting factor in the operation, because it takes a long time to apply the adhesive properly, especially with the fatigue that occurs from the poor ergonomic posture. The adhesive applicator is also slowed down because the cartridge must be replaced frequently, usually after gluing two 4 ft. by 8 ft. panels.

Other types of dispensers are used to spray low viscosity fluids, usually not adhesives, which have little resistance to flow through the small diameter hoses and tubes even though the length is relatively long. Typically, these fluids have the viscosity of water (about 1 cps), and the hoses and tubes are about ¼ in. to ⅜ in. in diameter. Often the hoses are specified for higher pressures because of higher flow rates and distance of throw required in spraying. High viscosity adhesives could not be used in these systems because their piston or gear pumps require gravity free flow into the intake, and these adhesives would cause cavitations. The hose and tubes of these dispensers are designed to be cleaned and reused. The use of a high viscosity adhesive would destroy the hose and tubes if it hardened in them.

Therefore, there is a need for an improved dispenser for high viscosity fluids.

### SUMMARY OF THE INVENTION

The present invention meets this need by providing an ergonomic fluid dispenser. The ergonomic fluid dispenser includes a fluid container having a fluid outlet, the fluid container holding about 5 pounds or more of a fluid, wherein in the fluid is a high viscosity fluid, a sticky fluid, a fluid which hardens, or combinations thereof; a dispensing assembly to dispense the fluid, the dispensing assembly in fluid communication with the fluid outlet; an optional carton; and at least one ergonomic strap or handle attached to the fluid container or the carton so that an operator may remain upright during application of the fluid.

Another aspect of the invention involves a method of dispensing a fluid using the ergonomic fluid dispenser.

### BRIEF DESCRIPTION OF THE DRAWINGS

FIG. 1 shows one embodiment of the ergonomic fluid dispenser.

FIG. 2 shows the components of the embodiment of FIG. 1.

FIG. 3 shows a schematic of the operation of one embodiment of the ergonomic fluid dispenser.

FIG. 4 shows different embodiments of the fluid outlet.

FIG. 5 shows a schematic of the operation of another embodiment of the ergonomic fluid dispenser.

FIG. 6 shows a schematic of the operation of another embodiment of the ergonomic fluid dispenser.

FIG. 7 shows another embodiment of the fluid container.

FIG. 8 shows another embodiment of the fluid container.

FIG. 9 shows still another embodiment of the fluid container.

FIG. 10 shows one embodiment of the ergonomic fluid dispenser having 2 fluid containers.

FIG. 11 shows one embodiment of the dispensing assembly.

FIG. 12 shows an alternate embodiment of the dispensing assembly.

FIG. 13 shows one embodiment of a shut-off valve for the dispensing assembly.

FIG. 14 shows one embodiment of the soft back pack of the present invention with the fluid container removed.

FIG. 15 shows another embodiment of the soft back pack of the present invention with the fluid container in a horizontal position.

FIG. 16 shows another embodiment of the soft back pack.

FIG. 17 shows another embodiment of the soft back pack with different side porting.

FIG. 18 shows another embodiment of the soft back pack with vertical porting.

FIG. 19 shows one embodiment of the hard back pack.

FIG. 20 shows the embodiment of FIG. 19 with the fluid container installed.

FIG. 21 shows one embodiment of the soft shoulder pack.

FIG. 22 shows one embodiment of the semi-rigid shoulder pack.

FIG. 23 shows one embodiment of the hard shoulder pack.

FIG. 24 shows another embodiment of the shoulder pack.

FIG. 25 show another embodiment of the shoulder pack.

FIG. 26 shows a vertical cross-section of the carton used on the embodiments of FIGS. 24 and 25.

FIG. 27 shows another embodiment of a back pack

FIG. 28 shows another embodiment of a back pack.

FIG. 29 shows another embodiment of a back pack.

FIG. 30 shows another embodiment of a back pack.

FIG. 31 shows another embodiment of a shoulder pack.

FIG. 32 shows another embodiment of a shoulder pack.

FIG. 33 shows one embodiment of the floor mount carrying case.

FIG. 34 shows schematics of different embodiments of the input energy/drive system.

FIG. 35 shows various devices which can be used to limit the internal pressure of the fluid container.

FIG. 36 shows one embodiment of a fluid dispenser without a carrying case.

FIG. 37 shows another embodiment of a fluid dispenser without a carrying case.

FIG. 38 shows another embodiment of a fluid dispenser without a carrying case.

FIG. 39 shows another embodiment of a fluid dispenser without a carrying case.

FIG. 40 shows one embodiment of a waistpack containing electro-pneumatic controls.

FIG. 41 shows one embodiment of a flexible dispensing tube.

FIG. 42 shows one embodiment of a dispensing tube with a shut-off valve.

### DETAILED DESCRIPTION OF THE INVENTION

The ergonomic fluid dispenser of the present invention includes a fluid container, a dispensing assembly, an input energy/drive system, and a carrying case for carrying the components.

The fluid container can utilize a two chamber concept, if desired. In one embodiment of this type of arrangement, there is a divider inside a bottle which separates the bottle into two chambers: an air chamber and a fluid chamber. The divider acts as a piston. When air is delivered to the air chamber side of the bottle, the air pressure pushes on the divider so that it applies a force against the adhesive on the other side of it. The applied force results in the adhesive being pushed out of the fluid container.

A dispensing assembly is connected to the fluid container. The diameter and length dimensions of the dispensing assembly are chosen so that a high viscosity adhesive can be dispensed at low pressure at a desired flow rate. The low pressure condition allows all of the components to be lightweight and low cost.

The ergonomic fluid dispenser includes a carrying case, such as a back pack or shoulder pack, for carrying the components. The back pack provides comfortable support and bracing of the loads on the operator's body. The shoulder assembly is similar to the back pack except that it typically extends over only one shoulder (although it can extend over both shoulders as in golf bag type of arrangement). It would typically be used for somewhat smaller fluid containers than the back pack. The shoulder assembly provides comfortable support and bracing of loads on the operator's shoulder and hip. Alternately, the carrying case can be designed to sit on the floor. It can include wheels and/or a handle for easy movement, if desired.

The ergonomic fluid dispenser may include an input energy/drive system which controls the pressurized gas (typically air) and powers the divider which pushes the adhesive out of the fluid container. It allows for a minimum weight of equipment while obtaining the power needed to dispense the fluid. The pressurized gas is typically a low pressure gas, generally less than about 40 psi, or in some embodiments, less than about 30 psi.

The ergonomic fluid dispenser is designed to dispense high viscosity fluids, sticky fluids, and/or fluids that harden, for example due to curing, crosslinking, or drying out. Fluids exhibiting one or more of these characteristics include, but are not limited to, one and two component adhesives, sealants, caulks, and gasket foaming materials. Some of the fluids are shear thinning, while others are less so. These fluids can be difficult to dispense because air has a tendency to tunnel through the fluid, creating a path in the fluid through which the air travels without moving the fluid.

The viscosity is generally at least about 4,000 cp, or about 10,000 cp, and can be up to 350,000 cp or more, depending on the particular type of fluid. It is typically in a range of about 10,000 cp to about 350,000 cp, or about 50,000 cp to about 350,000 cp, or about 100,000 cp to about 350,000 cp, or about 150,000 cp to about 350,000 cp, or about 200,000 cp to about 350,000 cp, or about 250,000 cp to about 350,000 cp, or about 300,000 cp to about 350,000 cp. Some two part polyurethane adhesives have a much lower initial viscosity, for example, about 250 cp for part A and about 900 cp for part B.

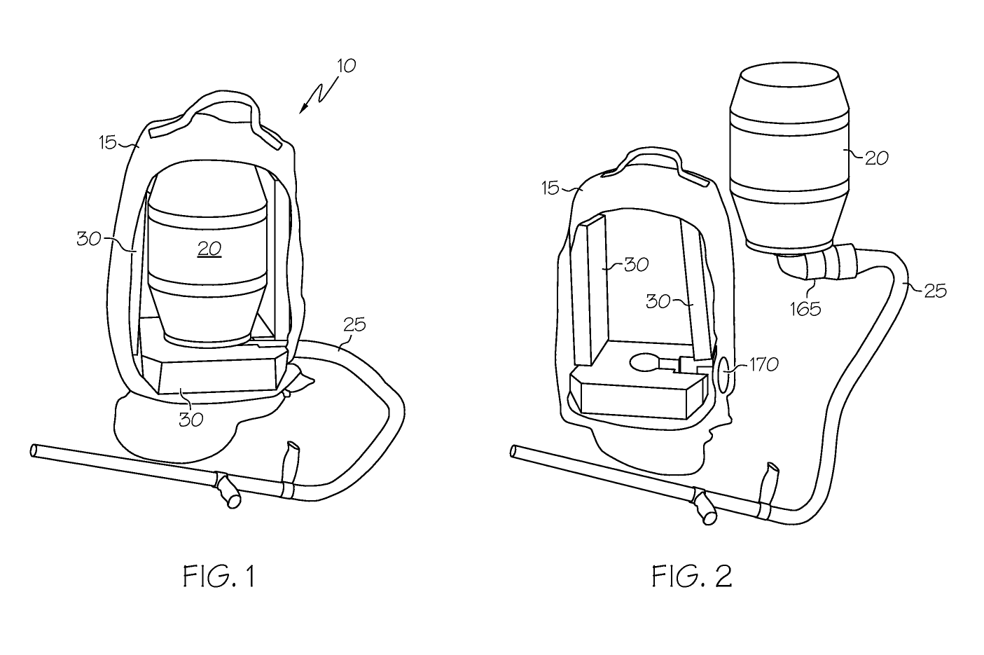

FIGS. 1 and 2 show one embodiment of the ergonomic fluid dispenser 10 of the present invention. The ergonomic fluid dispenser 10 includes a carrying case 15 for carrying the components. In this embodiment, the carrying case 15 is a back pack, and it is shown in the open position. There is a fluid container 20 inside the carrying case 15. A dispensing assembly 25 is attached to one end of the fluid container 20. The carrying case 15 can be fitted with cushioning 30 to protect the fluid container 20, if desired.

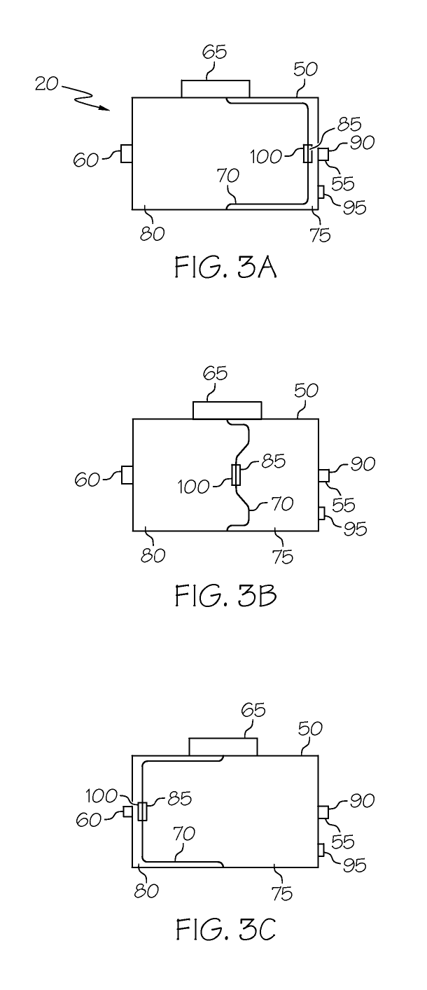

FIGS. 3a-c show one embodiment of the fluid container 20 of the present invention. The fluid container 20 includes a bottle 50. Although the present invention will be described for use with adhesive, it can be used with other high viscosity fluids which must be dispensed. The bottle 50 can be a relatively large bottle that can hold more than 5 pounds of adhesive, generally about 12 to about 25 pounds (or more, if desired). The size and shape of the bottle can vary depending on the particular application and quantity of adhesive needed. The bottle can be in one or more pieces. The bottle can be molded from a rigid plastic, such as polyethylene terephthalate (PET), high density polyethylene (HDPE), fluorinated HDPE, or similar plastics. The bottle can be made of a material with inherent barrier properties, such as PET or fluorinated HDPE. Alternatively, the bottle can be coated or treated, such as with metallization or fluorination.

There is an air inlet 55 on one end, and a fluid outlet 60 on the other end. The air inlet 55 and fluid outlet 60 can be molded integrally with the bottle 50, or they can be made as attachments, if desired. The fluid container 20 can optionally include a handle 65. The handle 65 can be molded integrally with the fluid container 20, or it can be attached separately.

Inside the bottle 50, there is a diaphragm 70 which is attached to or supported by the bottle 50. The diaphragm 70 has very little frictional drag, which helps reduce the pressure requirement. The diaphragm 70 divides the bottle 50 into two chambers: an air chamber 75 and fluid chamber 80. The air chamber 75 is formed between the diaphragm 70 and the shell of the bottle 50. When low pressure air is delivered to the air chamber 75, the air pressure pushes on the diaphragm 70 such that it applies force against the fluid chamber 80. This applied force or pressure on the fluid chamber 80 results in the adhesive being pushed out of the bottle 50. The diaphragm/bladder is configured such that it is only slightly larger than the size of the bottle, which allows the diaphragm/bladder to be supported by the strength of the bottle. As such, the diaphragm/bladder will not expand or burst at higher pressures. In addition, the diaphragm/bladder conforms to the shape of the bottle and pushes substantially all of the adhesive out of the bottle.

Suitable materials for the diaphragm/bladder include, but are not limited to, flexible plastics. The type of plastic may vary depending on whether the adhesive is water based or solvent based. Suitable plastics for water based adhesives, include, but are not limited to, high density polyethylene (HDPE), fluorinated HDPE, polypropylene (PP), polycarbonate, polyester, ethylenetrifluroethylene (ETFE), nylon and thermoplastic vulcanizate (such as Santoprene® available from Advanced Elastomer Systems). Higher barrier properties are needed for solvent based adhesives. Suitable plastics for solvent based adhesives include, but are not limited to, fluorinated HDPE, polycarbonate, polyester, ETFE, and nylon. Another way to achieve the necessary barrier properties is treat or coat the surface with a barrier. Examples of this include, but are not limited to, metallization, and fluorination.

The circumference of the diaphragm/bladder may be positioned in the middle of the bottle, typically at about midlength of the bottle. Thus, when the bottle is more than half full of adhesive, the flexible bladder is collapsed in on itself or the diaphragm extends towards the air inlet. When the bottle is less than half full of adhesive, the diaphragm or bladder is extended towards the outlet port. The respective positions during the movement of the diaphragm/bladder result in either an air or fluid bearing on the surfaces that reduce friction, which decreases the pressure and work requirements of the system. The design and flexibility of the diaphragm/bladder prevents the adhesive from leaking around it.

In the position shown in FIG. 3a, the bottle 50 is full of adhesive. The diaphragm 70 is hermetically sealed to the bottle 50 to form the air chamber 75. The air trapped between the diaphragm 70 and the bottle 50 acts as an air bearing when the hydraulic back-pressure pushes the diaphragm 70 against the inside of the bottle 50. The air bearing and the rolling motion of the diaphragm 70 minimizes the frictional drag as it moves. This helps support the diaphragm 70 and allows for higher air pressures without tearing or rupturing the diaphragm 70.

At the center of the diaphragm 70, a plug 85 could be attached so that it closes the air inlet 55 when the bottle 50 is full of adhesive prior to use.

The air inlet 55 could be capped during shipment. The air inlet 55 could have a quick disconnect connection 90 for an air tube, if desired. The air inlet 55 could also be designed to include a pressure relief valve to assist with release if the air exceeds the safety pressure of the bottle 50. Alternatively, a pressure relief valve 95 could be incorporated into the bottle 50.

FIG. 3b shows a partially used fluid container 20. The diaphragm 70 is moving towards the fluid outlet 60 as it folds in on itself. During normal operation, when there is adhesive and air on each side of the diaphragm 70, there is pressure on both sides so there is a negligible differential force on the diaphragm 70 to cause damage. The circumference of the diaphragm 70 can be attached to the inside of the bottle 50 with tape. It could also be attached to the bottle 50 by adhesive, welding, or mechanical connection, such as a ring clip snapped into a groove in the inside of the bottle 50. The diaphragm 70 could also be captured in a joint if the bottle 50 is molded in two pieces and the three parts then assembled. The diaphragm 70 could be molded as part of the bottle half that forms one of the chambers, with the diaphragm portion being of reduced thickness to maintain flexibility. The two halves would then be connected. If a bladder is used inside the bottle, it could be similarly attached at mid-length of the bottle, and the fluid container could be constructed as a two or three part assembly. The diaphragm/bladder could have a color line to aid in the visual inspection of the position and contents inside the bottle 50.

FIG. 3c shows an almost empty fluid container 20. The diaphragm 70 is almost all of the way to the fluid outlet 60. There is residual adhesive in the fluid chamber 80. The adhesive trapped between the diaphragm 70 and the bottle 50 acts as a fluid bearing when the air pressure pushes the diaphragm 70 against the bottle 50. The fluid bearing and the rolling motion of the diaphragm minimizes the frictional drag as it moves. If the fluid chamber is formed by a bladder folded back on itself, the bladder would be unfolding inside-out as the adhesive is pushed out of the outlet port. Because the diaphragm or bladder is sized comparable to the volume of the bottle, substantially all of the adhesive can be squeezed out of the fluid chamber.

If the diaphragm/bladder is attached at about the midpoint of the bottle 50, the diaphragm/bladder cannot extend into the fluid outlet 60 causing it to interrupt the flow of adhesive prematurely. A plug 100 can be attached at the center of the diaphragm 70 which will force the adhesive out and close the fluid outlet 60 when the bottle 50 is empty.

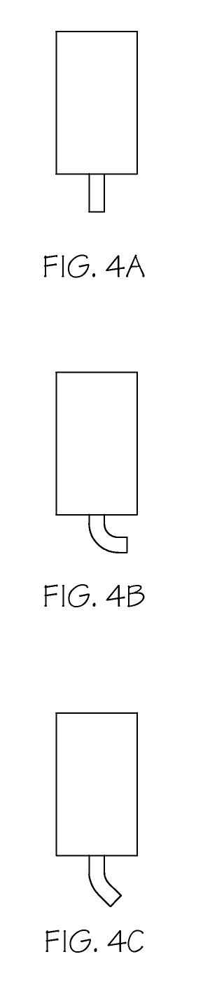

The fluid outlet 60 can be a straight connection, if desired. It can be of a size and shape to minimize the pressure drop across the fitment. It could also be an angled connection, such as a 45 or 90 degree connection as shown in FIG. 4, if desired. The fluid outlet 60 could be a separate part, or an integral part of the bottle 50. The fluid outlet 60 can be hermetically sealed and covered with a cap during shipment and prior to use when the operator is loading the bottle 50 into the ergonomic fluid dispenser 10.

Because of the diaphragm 70 in the bottle 50 and the way it reacts to the air and hydraulic pressures on it, the discharge of adhesive from the fluid container 20 is relatively controlled and uniform. The discharge position is typically downward, although it can be horizontal, or upward, if desired. This allows variation in the application positions, and flexibility in the ergonomic dispenser designs.

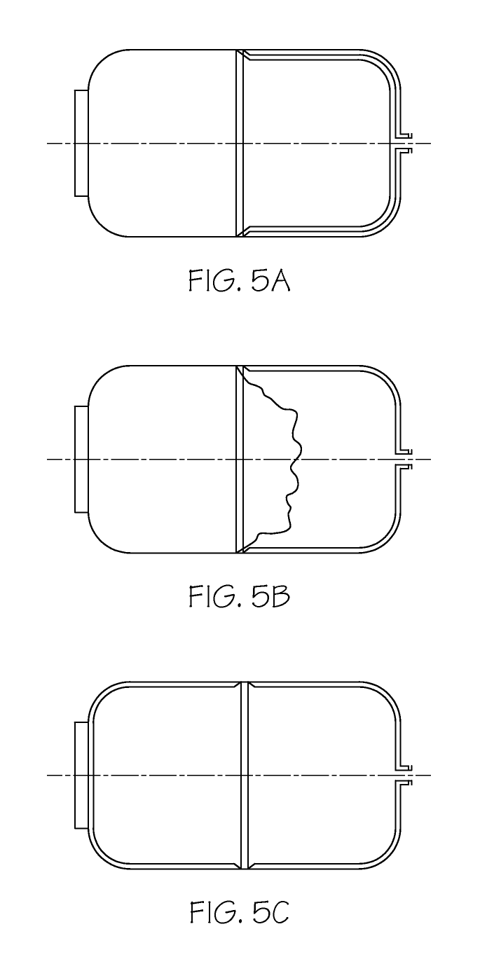

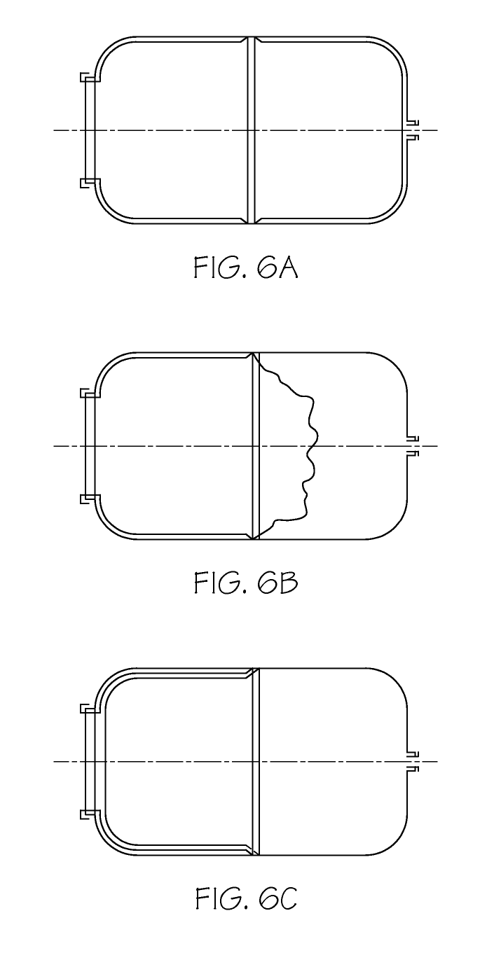

The air chamber could be formed by an air bladder or air bag with the opening attached to the air inlet port. The air bag or bladder would be more integral and provide a more hermetic air chamber than a diaphragm. The air bladder would be folded back on itself such that one half of it would be folded outside in. The air trapped between the fold of the air bladder acts as an air bearing against the hydraulic back pressure much like in the diaphragm case. FIGS. 5a-c show an air bag or a bladder. The air fills the bladder as the adhesive is forced out of the bottle.

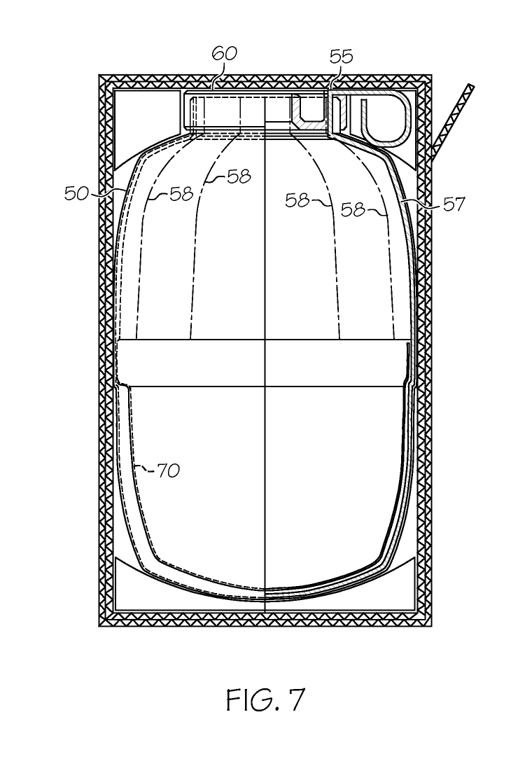

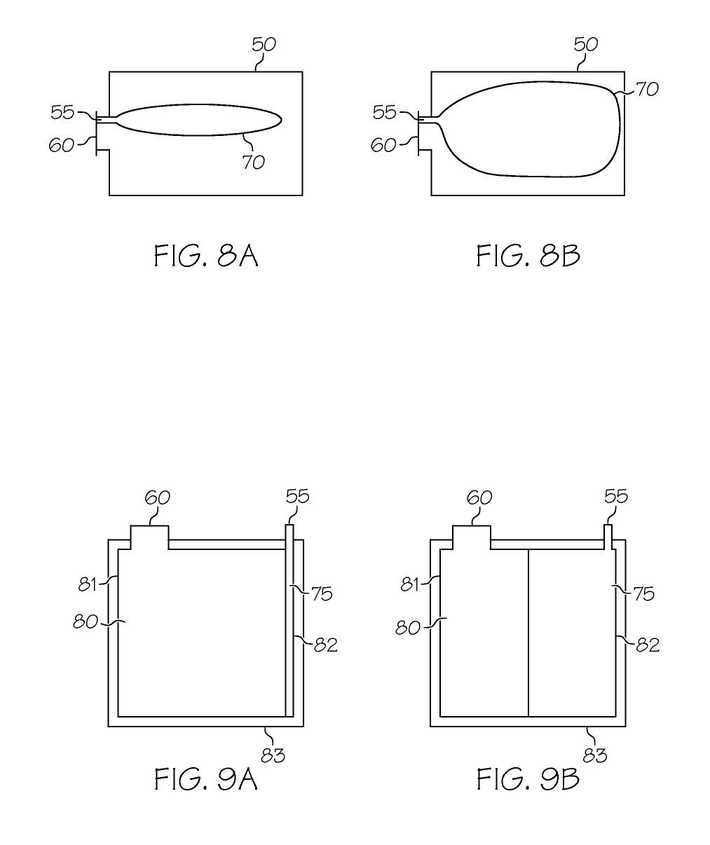

The fluid chamber could also be formed by a bladder or bag with the opening attached or located at the outlet port of the bottle. The bag filled with adhesive would collapse outside in as the bag emptied toward the outlet port. The bag opening or exit would be either attached at the neck of the bottle or captured by the fitment cap on the bottle if a three-piece assembly was used. A bag with a large opening (or smaller ratio between the bottle v. neck diameter) is easier to mold in production, especially a rubber thin skin that is needed to hold a solvent based adhesive. Also, the molded bag could have differential thickness or ribs at the outlet port half of the bladder to help keep it from collapsing from pressure on the outer airside or stickiness pull-force on the inner adhesive side of the bladder/bag. FIGS. 6a-c show an adhesive bag or a bladder. The bladder collapses as the adhesive is forced out of the bag.

With higher viscosity fluids, it may be desirable to lubricate the inside of the bottle and/or the bladder/bag/diaphragm to help with fluid flow. Because the lubricant is in contact with the fluid, the bottle, and the bladder/bag/diaphragm, the lubricant should be selected so that it is compatible with these materials. Suitable lubricants include, but are not limited to vegetable oils, hydrocarbon oils, polytetrafluorethylene sprays, mold release compounds, and the like.

FIG. 7 shows another embodiment of the fluid container. In this arrangement, the air inlet 55 and the fluid outlet 60 are located at the same end of the bottle 50. An air tube 57 runs through the fluid outlet 60 along the inside of the bottle 50 to the underside of the diaphragm 70. The air tube 57 intersects the bladder 70 and creates a potential air leak path. This could be controlled using caulk or the adhesive itself. The advantage of this arrangement is that the bottle can be a more standard and lower cost design because the bottom will not include an air inlet. In addition, it may be more economical to incorporate the air inlet into the cover for the fluid outlet.

Another embodiment is shown in FIG. 8. The air inlet 55 and fluid outlet 60 are at the same end of the bottle 50. The bladder 70 is shaped like a balloon, and it extends into the bottle 50 which is filled with adhesive surrounding the collapsed bladder 70. The bladder can be formed with appropriate wall thicknesses such that the bladder inflates first at the far end, similar to a typical balloon. The bladder gradually expands out against the inner wall of the bottle such that is forces the adhesive out of the bottle. When the bladder is fully inflated, substantially all of the adhesive will have been forced from the bottle.

FIG. 9 shows still another embodiment of the present invention. There is a fluid chamber 80 with a fluid outlet 60. The fluid bladder 81 forms the fluid chamber 80. The fluid bladder 81 can be made from a flexible, semi-rigid material which can collapse, such as high density polyethylene. A separate air bladder 82 forms air chamber 75 with an air inlet 55. The fluid bladder 81 and the air bladder 82 can be contained in a reinforced carton or box 83. When the air bladder 82 expands, it collapses the fluid bladder 81, forcing adhesive into the dispensing assembly. If desired, the air bladder 82 and the fluid bladder 81 could be attached to one another, using reinforced tape, for example. This arrangement has the advantage of being inexpensive.

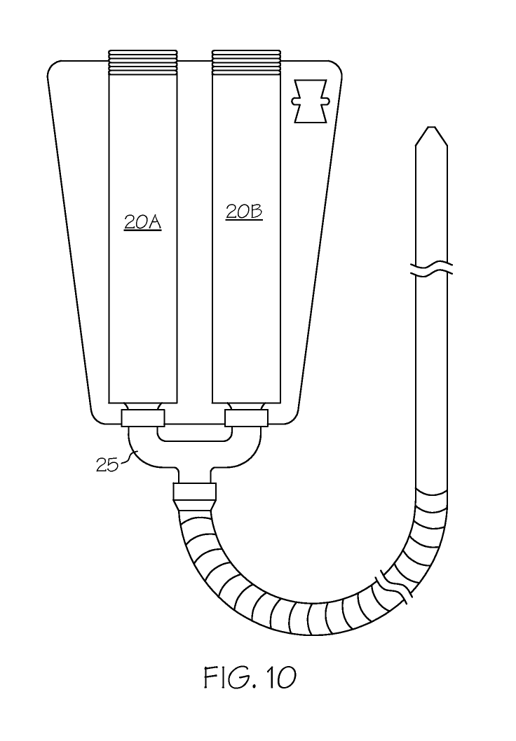

The fluid container could also be used for a two component adhesive. The fluid container could be designed with 2 fluid containers in a single fluid container or carton. The 2 fluid chambers could be formed by 2 bladders in the fluid container. Alternatively, there could be two separate fluid containers 20a and 20b joined to a common dispensing assembly 25, as shown in FIG. 10.

The fluid container helps with the ergonomic design because the low pressure arrangement allows the use of a lightweight bottle. The bottle is easy to handle and durable. The fluid container is reliable because the diaphragm is the only moving part, and it is a consumable. It is also cleaner because the diaphragm/bladder contains the adhesive better and empties the bottle more completely. The fluid container can be used with different kinds of dispenser hardware, making it a flexible system. When the bottle includes barrier properties (either inherently or because of a coating), the storage life of the adhesive can be increased. The fluid outlet and related fitment can be designed so that there is a minimal pressure drop or flow resistance. The air inlet and fluid outlet can be designed to improve the safety and ergonomics of their respective fitments.

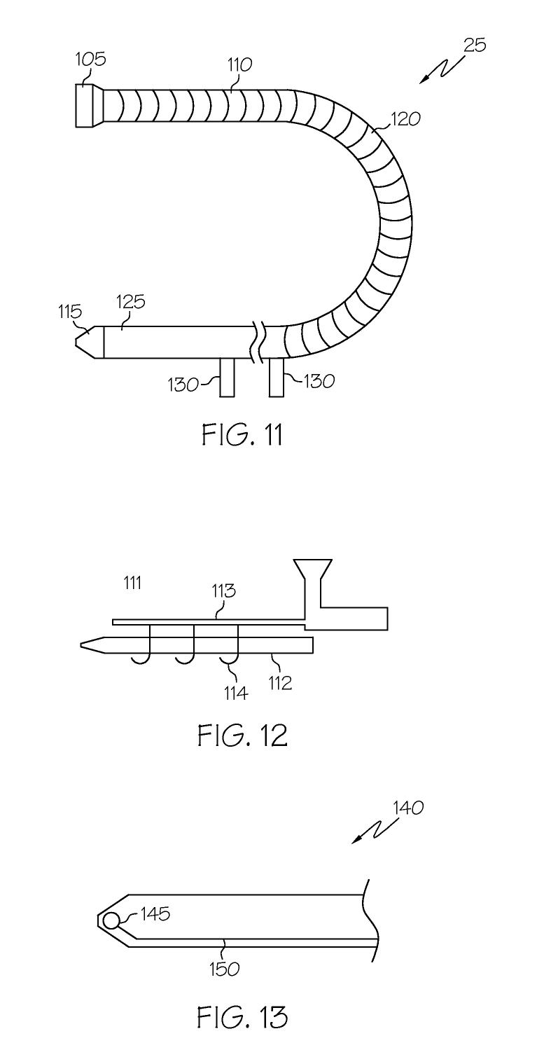

As shown in FIG. 11, the dispensing assembly 25 can include a fitment 105, a dispensing tube 110, and a nozzle 115. The fitment 105 can be straight or have an angle, if desired. The fitment 105 allows easy attachment to the fluid outlet 60 of the fluid container 20. There is a dispensing tube 110 connected to the fitment 105. The dispensing tube 110 can include a flexible section 120 and a rigid tube section 125. Alternatively, the dispensing tube 110 can be entirely flexible or entirely rigid, if desired. The dispensing tube 110 typically includes a flexible section 120 which allows flexibility and movement. A rigid tube section 125 which provides handling and control for longer extensions can be included in some applications. The nozzle 115 determines the flow pattern and can be of a desired shape and size depending on the application. The dispensing assembly 25 can be designed for efficiency of hydraulics, ergonomics, and/or economics.

FIG. 12 shows an alternative embodiment of the dispensing assembly 25. In this arrangement, there is a tube support 111. The tube support 111 holds a flexible bag hose 112. The tube support can have a rigid rod 113 and support hooks 114, for example. The flexible bag hose 112 would hang or mount on the tube support 111, and it would attach to a fitment, directly to the fluid outlet, or to a flexible section. The adhesive would be dispensed through the opposite end of the flexible bag hose 112. This design is very inexpensive, and the flexible bag hose could be thrown away after use. Also, the flexible bag hose could be easily emptied of adhesive either manually or using a squeegee with nip rollers.

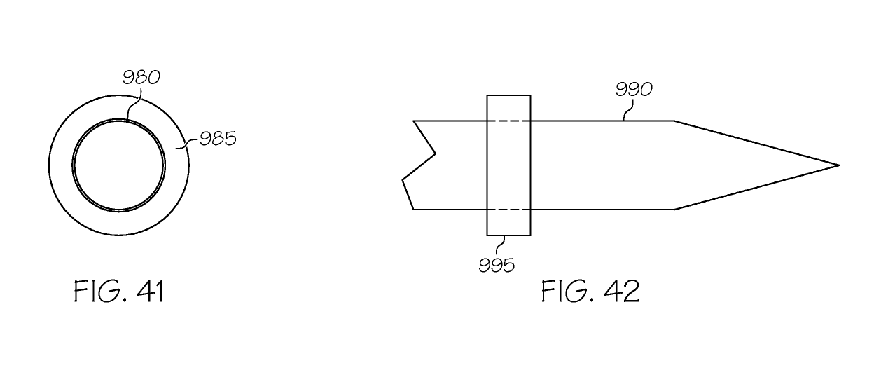

The flexible bag hose could be a hose assembly that includes a film tube inside a flexible woven fabric sheath, as shown in FIG. 41. The sheath 985 provides strength for the film tube 980. If the assembly is flat, it is easier to store when empty, and it provides good flexibility when pressure causes it to round out. It provides the ability to use higher pressures and offers good durability. This hose assembly should be low cost, and could be disposable after use.

The dispensing assembly 25 may be kept air tight and hermetic so that moisture or solvent in the fluid material will not escape or evaporate, and thus dry out or harden the adhesive or fluid material. The material used for the construction may have barrier properties either inherently or because of a coating. A shut-off valve and an actuator for the shut-off valve, such as a trigger, can also be included, if desired.

In short-term storage, the fluid material may form a skin or seal where it is exposed at the end of the nozzle tip. This is not generally a problem because it can be easily unclogged when the system is used next. With long-term storage, the material will eventually cure in the dispensing tube 110 and render it unusable. This may also not be a problem because the components of the dispensing assembly 25 can be designed to be low cost so they can be used and thrown away.

The fitment 105 typically includes a female connection that attaches to a male connection on the fluid outlet 60 of the bottle 50, although the reverse arrangement could be used, if desired. In the typical arrangement, the fitment 105 has an effective diameter equivalent to, or greater than, the dispensing tube 110. The internal diameter and shape is designed to minimize the pressure drop across the fitment 105 and maximize the hermeticity with a seal. The connection can be secured with cam-locks, snap-latches, threaded connection, or other connection, as long as it provides a good mechanical seal. Desirably, the connection will easily and quickly attach to the fluid container 20, while not allowing the fluid to contaminate the outer surfaces of the fitment.

The fitment 105 is designed to minimize stress and strain with a flexible connection that can rotate or is synchronized to the position of the bottle 50. The dispensing tube 110 generally includes a flexible section 120 next to the fitment 105 which also reduces the stress and strain at the connection. The fitment 105 can be configured as either a straight connection or an angled connection to improve the operation and ergonomics for a particular application. The fitment 105 can be attached to the dispensing tube 110 with a hermetic connection, or it can be integral with the dispensing tube, if desired. The fitment 105 can be designed using low cost materials so it can be disposable, if desired.

The design of the dispensing tube 110 depends on the individual application for which it is to be used. A flexible section of approximately 38 inches accommodates the movement and balance needed for good ergonomics in many applications. Given the volume of adhesive contained in the dispensing tube 110 for longer configurations, the balance of weight between the flexible section 120 and the rigid section 125 helps to reduce the torque on the operator's wrist.

The optimum length of rigid section 125 varies depending on the particular application involved. For sub-floor applications, the optimum length of the rigid section is about 38 inches. For dry wall applications, the optimum length of the rigid section is about 28 inches. For close-up flexible applications, such as joints on HVAC ducts, the optimum length is about 12 inches, or long enough for a handle and a shut-off switch. There may be some applications where only a flexible section is used, or only a rigid section is used. The dispensing tube could be a telescoping tube, allowing the length of the tube to be adjusted, so that the same dispensing tube could be used for different applications. It could include a section which is foldable for easier storage when not in use.

The dispensing assembly 25 is designed to minimize the work out-put and thus the pressure required for the applications. The sub-floor application is the most difficult dispensing assembly 25 because it requires the longest dispensing tube 110. The work out-put is the product of the resistance forces of the fluid applied along the length of the dispensing assembly 25. The resistance forces include the frictional forces along the wall and the endogenous flow resistance in the fluid, all of which are affected by turbulence and the chemistry of the fluid. The analysis and testing for a given flow rate confirmed that the applied force required to move the fluid was directly proportional to the length of the system and exponentially proportional to the inverse diameter of the dispensing assembly 25. Therefore, a larger diameter dispensing tube 110 allowed for a lower applied force to move the fluid in a given length, which resulted in a lower pressure drop across the dispensing assembly 25. The analysis and testing of various dispensing tube size configurations showed that an internal diameter of about 1.25 inches was optimum for keeping the pressure drop across the system to about 15 to about 20 maximum psi of differential pressure. As such, the input operating pressure for the system would be low, about 15 to about 20 psi pressure for the desired maximum flow rate of approximately 10 g/sec for a high viscosity adhesive. As a low pressure system, the components of all of the assemblies can be made with plastic materials and minimal wall thickness to withstand the corresponding hydraulic hoop stresses. The lightweight plastic components allow the weight of the system components to be ergonomically friendly. Testing also showed that a dispensing tube diameter of about 1.25 inches is about the maximum that could be tolerated ergonomically. Above this maximum diameter/volume for the longest dispensing tube lengths, the weight of the dispensing tube when filled with adhesive became objectionable because it put too much load on the operator's hand/arm. The system was developed based on a one-part adhesive fluid (although it could also be used with multicomponent adhesives and fluids) with a viscosity of about 250,000 cps, which is very high compared to fluids usually dispensed through a hose and tube assembly at low pressure. Fortunately, the fluid is thixotropic, and the viscosity decreases as the flow rate increases. The thixotropic condition worked in favor of the dispenser system because the viscosity was highest and the flow rate lowest when the adhesive was in the bottle, and the viscosity was lowest and the flow rate highest at the nozzle. The thixotropic condition helped keep the resistance forces lower. The internal flow resistance of the fluid also affected the force and pressure required to push the fluid through the dispensing assembly 25. The stickiness of the adhesive to itself caused higher forces and pressures compared to caulks, which had more internal lubricity and flowed faster at the same pressures. Since the system has a relatively constant pressure input along with fixed sizes along the flow path, any variations in the volume of flow or flow rate from the nozzle would primarily be a function of the consistency or quality of the fluid material. During testing, the slight variations in flow rate that were noticed were acceptable for the applications. However, the consistency in viscosity can be important given the temperature range in the field, particularly when it is cold.

During start-up, the stickiness of the adhesive to the wall of the dispensing tube was noticed as the dispensing tube gradually filled. The friction of the adhesive against the clean inside wall caused a slower flow rate until the wall of the dispensing tube was covered with adhesive, then the flow rate increased because there was less friction within the adhesive itself. There did not seem to be a thickness build-up of adhesive on the wall of the dispensing tube during operation, and there may be a certain amount of scrubbing or replacement of the adhesive attached to the wall.

Desirably, the dispensing assembly will remain hermetic during storage so that the adhesive inside does not cure or become hard. Air should not be allowed to migrate inside, and the moisture in water-based adhesive or the solvent in solvent-based adhesive should not be allowed to evaporate or vaporize out. Therefore, the materials from which the components are made may have inherent gas, water, and/or solvent barrier properties or a barrier coating with these properties may be applied. In addition, the joints of the assembly should be tight and sealed to prevent leakage, or gas transmission. The adhesive at the nozzle tip will skin over and slow down any leakage, evaporation, or vaporization that might occur from stoppage during application. Any curing at the tip can be cleared, and the application can continue. However, a cap or plug on the nozzle is recommended for long-term storage between applications.

The design of the nozzle 115 affects the desired flow of the fluid. In addition, the greatest pressure drop, about ⅓ of the system pressure drop, occurs at the nozzle. A tapered nozzle allows for various hole diameters depending on the location where the tip is cut off. This affects the size of the bead of adhesive, which may vary for different applications. The aperture is typically between about ¼ inches to about ⅜ inches in diameter. The end of the tip can be angled, or notched in order to apply a round bead of adhesive without being obstructed, but other shapes can be used, if desired. A fan or flared tip might be appropriate for applying caulk, for example. The nozzle head attached to the dispensing tube 110 can have a standard size with a hole that allows for the attachment of special shaped tips, if desired. The shape and size of the nozzle tip and the dispensing tube should not obstruct the view of the operator in seeing the bead being applied. The tip can be constructed with attachments such as fingers, rollers, or other arrangements that help guide the tip for certain applications.

An optional shut-off valve can be included to prevent drippage from the nozzle tip, if desired, as shown in FIG. 13. In many applications, drippage is undesirable, particularly in indoor applications. Shut-off can be accomplished by stopping the air supply or reducing the air input pressure, but a lag factor will occur before flow stops. Although high viscosity fluids will not drip very much because of their flow resistance, lower viscosity fluids would have excessive drippage even at reduced input pressure. In addition, it may not be desirable to reduce input pressure during operation because the air pressure counterbalances the weight of the material in the fluid container. Depending on the position of the system and the application, if the weight of material drops or pulls away from the dispensing assembly, a backpressure or vacuum may be induced on the fluid material. This could result in the potential for air to be drawn into the dispensing tube and the entire system, causing the fluid material to dry out and clog up the dispensing tube before it is ready to be replaced. Therefore, a shut-off valve may be desirable to block the flow of the fluid material.

The shut-off valve 140 is desirably located close to the nozzle tip. This keeps the drippage to a minimum and maximizes the hermeticity of the dispensing tube. In one embodiment, the shut-off valve 140 in the nozzle can include a tapered seat and a round ball 145 as a plug. The tapered seat reduces the friction pressure drop across it, and the lead-in assures alignment of the ball. The ball 145 is attached to a push/pull rod 150 that extends along the inside of the tube up to an actuator lever or similar structure located near or at the hand grip on the dispensing tube. The actuator lever extends through a flexible fitment seal in the dispensing tube wall and attaches to a trigger that has a spring return. This internal rod design is relatively simple, is protected from outside forces which could damage it, and does not interfere with the flow. External push/pull cables and other actuator locations could be used, but they might be more vulnerable to damage.

In another embodiment, the shut-off valve could be included as part of the actuator in a design located near the handgrip. This may be less desirable because it exposes the dispensing tube to more air penetration and undesirable drying and/or curing of the fluid material. However, if the dispensing tube is disposable, this would not matter. In one embodiment, an external pinch valve comprising a ball and diaphragm could be used as a shut-off valve in the dispensing tube. When the operator pushes the ball with a finger, the diaphragm extends down into the dispensing tube and blocks the flow.

Shut-off valves including pinch or sphincter type valves are desirable, particularly for flexible dispensing tubes. As shown in FIG. 42, these valves 995 can be externally actuated and collapse the outer diameter of the dispensing tube 990. Hermeticity is improved because there is no valve stem protruding through the wall. Valves which are normally closed and which are opened by actuation of the valve are preferred. However, normally open valves can be used. Normally open valves preferably include a lock position to ensure that the fluid does not drain out when the dispenser is not being used.

If the dispensing assembly is to be stored, caps, plugs, or other suitable closure devices could be attached to the exposed ends.

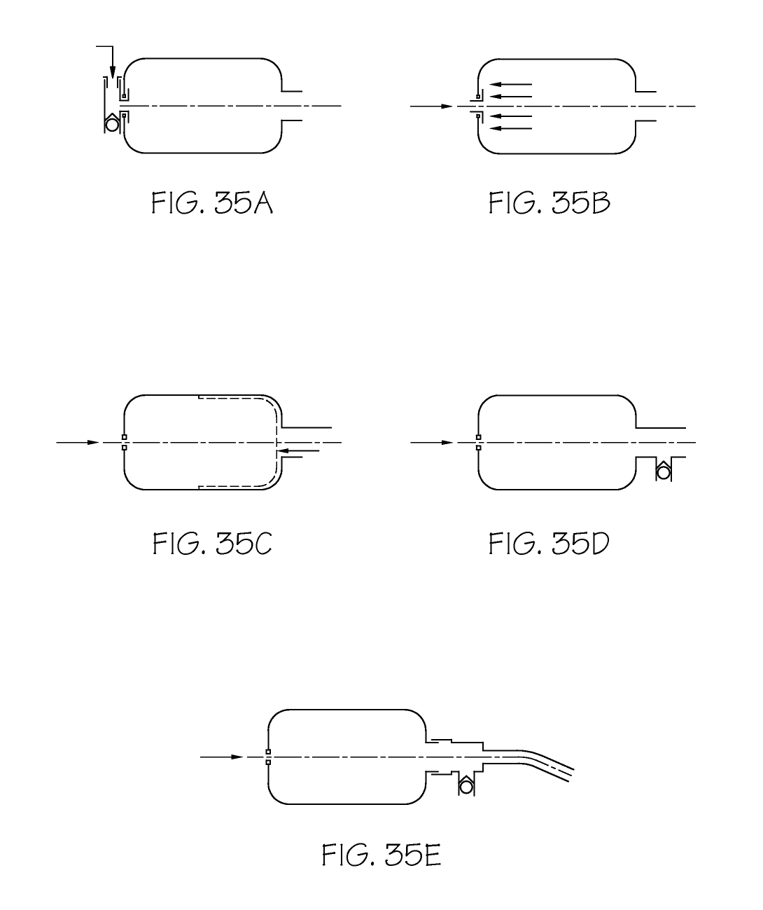

An optional sensor can be included which detects when the bottle is empty and should be replaced. This allows the dispensing tube to be kept full. Suitable sensors include, but are not limited to, pressure sensors, proximity sensors, or other contact sensors. These sensors could be used to detect an empty bottle. For example, in FIG. 35a, the pressure relieve valve/switch, located on the bottle or back upstream in the airline at the controls, could indirectly detect the bladder position when empty. As the bladder pushes against the empty end of the bottle, a higher pressure than the maximum operating pressure would build up. This would trip the pressure relief valve or switch, such that the air would escape and the noise would be heard or a electrical signal could turn on a light, etc. that would notify the operator. Alternatively, in FIG. 35c, a proximity switch control could be used. When the bladder reached the end of the bottle, an electronic sensor would detect a metallic or non-metallic target attached to the bladder, tripping the sensor and enabling a horn or light signal. Alternatively, in FIG. 35c, an electro/mechanical switch could be attached thru or against the surface at the end of the bottle, such that a direct mechanical force from the bladder would trip the sensor and enable a sound or light signal.

The dispensing assembly 25 can include handles 130 which are designed to maximize the ergonomics of the operator for the specific application. The size, shape, position, and number of handles will likely be different for different applications. The ergonomic handles could be molded in various configurations, either as an integral part or as an attachable part of the dispensing tube. The handles 130 could be connected in-line or attached externally to the dispensing tube assembly. The externally attached handle could be adjustable and assembled in the field, if desired. If there is more than one handle, they can be on the same side, on opposite sides, or at an angle to one another. The handle could include a push-button or trigger that operates the shut-off valve, if desired.

The sub-floor application will probably include only one handle, generally perpendicular to the dispensing tube, because it is primarily used on a horizontal surface and the extension of the dispensing tube needs to be one handed. It is also a down-hand application, in which the weight of the dispensing tube is balanced and supported by the operator's wrist/arm and the joists of the sub-floor. A second handle can be used for better control at close-in positions.

The dry wall application will likely have two ergonomic handles because it is used on a vertical surface and the extension of the dispensing tube is both upward and downward. Two handles will help the operator support and balance the weight of the fluid filled dispensing tube. In the vertical position, the second handle will also improve the control of the nozzle tip. The handles can be offset from one another at about a 90 degree angle, if desired.

For some other applications, such as the sealing of HVAC ducts, where the length of dispensing tube is relatively short and therefore lighter and easier to control, an ergonomic handle may not be needed. Because the dispensing tube would be mostly or entirely a flexible section and the maximum range of flexibility is needed, the end of the dispensing tube could probably be gripped by one hand and controlled by the wrist since the application is within the operator's reach. In other applications, it might be advantageous to have a handle parallel to the dispensing tube that would allow gripping with one or two hands.

Another part of the fluid dispenser 10 is the carrying case 15. The carrying case can be a back pack style or a shoulder pack style, for example. Alternatively, the carrying case can be a floor unit. The carrying case can be soft and flexible, semi-rigid, or hard. The soft carrying cases can be made of a strong flexible material, such as ballistic nylon or a similar fabric. Semi-rigid carrying cases can be made of plastic. The hard carrying cases can be made of hard plastic or metal.

The advantages of the carrying case are both operational and ergonomic. The lightweight carrying case allows the operator to carry a larger capacity of adhesive, about 5 lbs. or more, about 10 lbs. or more, about 15 lbs. or more, about 20 lbs. or more, about 25 lbs. or more, or about 30 lbs. or more comfortably. The floor unit can hold even more adhesive because the ability of the operator to carry the weight of the adhesive is not an issue. The carrying case typically weighs about 5 lbs. to about 10 lbs. with controls, which with a typical amount of adhesive, about 25 lbs., provides an adhesive to container ratio between about 2.5 to 1 and 5 to 1, much better than the about 1 to 1 ratio of the existing hand guns. The carrying case can include one or more ergonomic adjustable shoulder straps, front cross straps, belts, lumbar or other braces, and hip flaps, all which are designed to make the carrying case supportive and comfortable to wear. The carrying case puts the operator in an upright position during dispensing, which reduces leg and back fatigue. The input energy/drive system, such as a pneumatic source of power, and fluid container also improve the ergonomics of the wrist and hand, which reduces the potential for carpal tunnel problems. The large pneumatic and adhesive capacity of the carrying case allows the operator to dispense adhesive rapidly and uniformly over a greater number of panels before refill is required. The carrying case with 25 lbs. of adhesive will have to be refilled 1/12 as often as the cartridge hand gun of the prior art. This should speed up the operation and eliminate the bottleneck in the sub-floor crew. The carrying case also makes it easier to replace the fluid container. The carrying case allows the operator to position the output of the fluid container so that it is optimal for the particular dispensing application. The carrying case makes it easier for the operator to comply with specifications and apply the proper amount of adhesive. In addition, the carrying case does not have external moving parts or hardware that would be subject to damage, and it provides additional protection for the fluid container during use and if the equipment is mishandled.

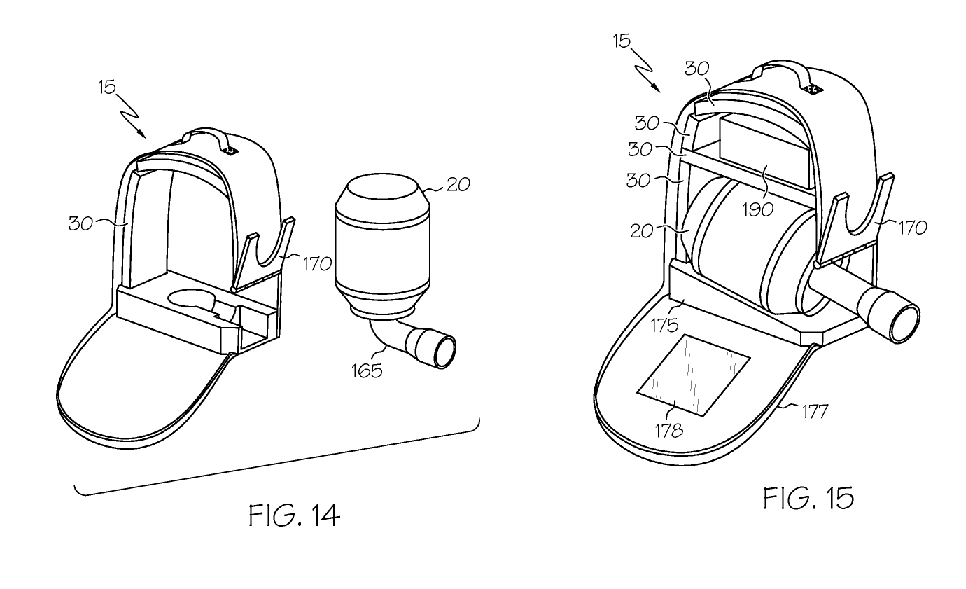

FIG. 14 shows the inside of the soft back pack style carrying case 15 when the front flap is opened and folded down for full access with the fluid container 20 removed. The cushioning 30 can be placed on the sides, top, and bottom of the back pack 15, surrounding the fluid container 20 and protecting it from damage if the back pack 15 is mishandled. The fluid container 20 is oriented vertically in the back pack. There is a right angle side discharge port 165 with a reinforced flap opening 170 on the right side of the back pack 15. A similar flap opening could be placed on the left side for a left handed operator. The flap opening 170 allows the fluid container 20 and dispensing assembly to be removed from the back pack 15 while connected. This is desirable to keep the back pack 15 clean while changing the fluid container 20. Although FIG. 14 shows a side discharge port 165, a fluid container 20 with a vertical discharge port could also be used. It would require a different cushion and a reinforced flap on the bottom of the back pack. The front panel design of the back pack would also have to be changed, with one or more side hinges or a different zipper arrangement, so the front would swing open for access to the fluid container. The front of the back pack can include a slotted opening or a see through panel so that the operator can visually inspect the contents of the fluid container 20 without opening the back pack 15, if desired.

FIG. 15 shows the inside of another arrangement of the soft back pack style carrying case 15. The fluid container 20 is in a horizontal position. A reinforced contoured bottom 175 supports the fluid container 20. The contoured bottom 175 could be designed so that the fluid container 20 is tipped slightly to take advantage of gravity at discharge, if desired. The fluid container 20 can be surrounded by cushioning 30, if desired. FIG. 15 shows a side discharge port and a straight connector. However, other connections, such as a right angle connection directed to the back of the back pack, could be used to help improve the ergonomics. The back pack can have a reinforced flap opening that can be opened when the fluid container is removed.

The front panel 177 of the back pack could include an opening or a see-through covering 178 to allow the operator to visually inspect the contents of the fluid container without opening the back pack, if desired.

The back pack can include an upper chamber for an input energy/drive system 190, such as a battery operated air pump or other pneumatic controls. The input energy/drive system 190 can be surrounded by cushioning 30 which helps protect the assembly from external damage, as well as absorbing any sound generated by the assembly. Although the input energy/drive system is shown as being positioned above the fluid container, the positions could be reversed, if desired.

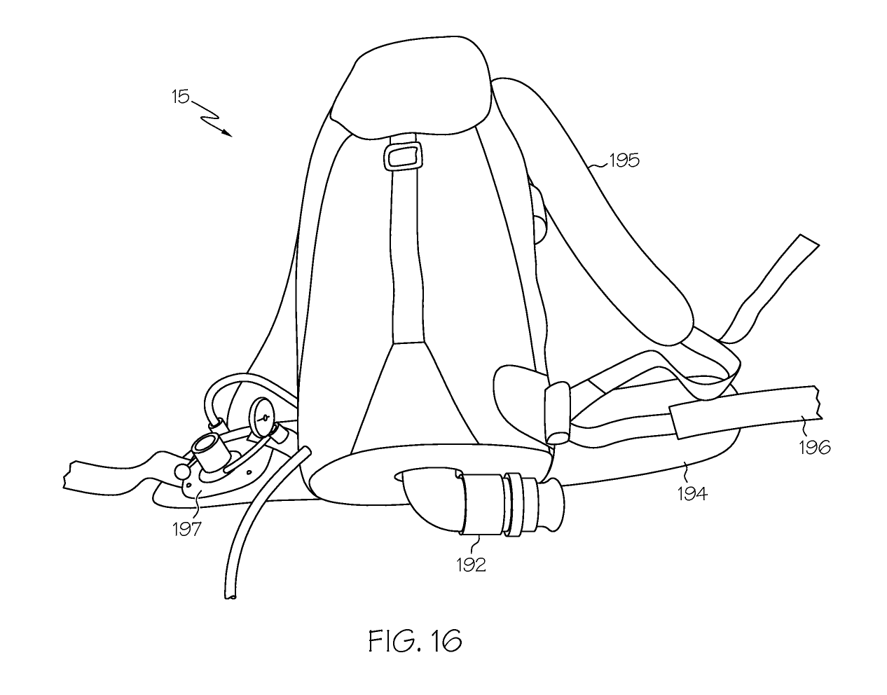

FIG. 16 shows another type of soft back pack style carrying case 15. It is a top loading design that can be used to carry a vertically positioned fluid container (not shown). The design has a bottom ported discharge with a right angle connection 192. Alternatively, it could have another type of connection, such as a straight connection or an angled connection with a different angle. The back pack includes a lumbar brace at the back, adjustable shoulder straps 195 on the top, and hip flaps 194 extending from the back pack to become a waist belt 196. In addition to supporting the load on the hips and legs, the hip flaps 194 can be used to mount pneumatic apparatus 197 for controlling the fluid dispenser.

The soft style back packs are relatively lightweight because of the elimination of heavy hardware. The soft back pack weighs approximately 5 lbs. when empty, or 10 lbs. with controls, and is capable of carrying a full fluid container weighing as much as about 25 lbs. As such, the soft back is very ergonomic with respect to force criteria. It is also ergonomic with respect to posture criteria because it is comfortable and adjustable to the operator, in addition to allowing the operator to work in a standing position. The soft back pack is very durable and unlikely to be damaged when dropped or mishandled because it is made of a ballistic fabric and cushioned with foam.

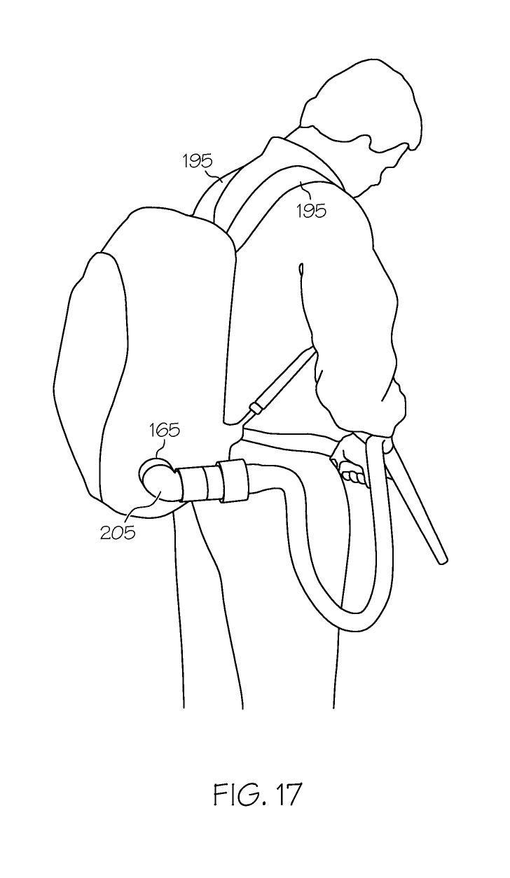

FIG. 17 shows a soft back pack style carrying case 15. The soft back pack 15 is supported on the back of the operator with two shoulder straps 195, allowing the operator to have both hands free during a dispensing application. In this embodiment, the back pack 15 is shown with side porting. Side porting is advantageous because it locates the dispenser port at the mid-height of the operator. This enables the operator to reach up and down easily with the shortest length of dispensing tube during the application. This configuration is desirable for applying adhesive on dry wall applications. FIG. 17 shows a side discharge port 165 with a 90 degree connection. Because the back pack 15 is adaptable for various types of porting and connections, it allows for improvement in ergonomics and performance.

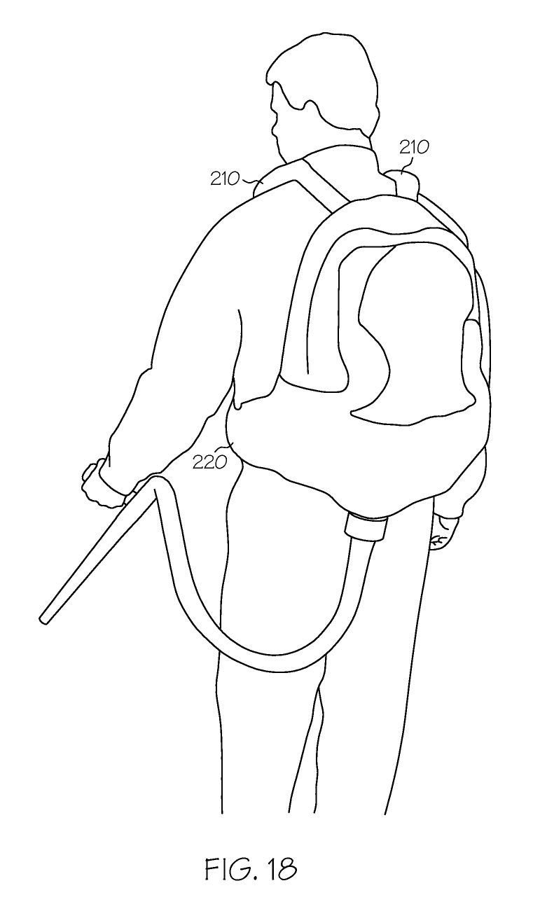

Another embodiment of the soft back pack 15 is shown in FIG. 18. The back pack includes shoulder straps 210 connected by front cross straps (not shown), and hip flaps 220. The hip flaps 220 extend from the back pack 15 and form a belt strap. The bracing in the back and lower part of the back pack is connected to the hip flaps 220 on each side, which rest on the hips of the operator. This allows the load of the back pack 15 to be transferred from the back to the legs of the operator. The fluid container has vertical porting and a straight connection. The vertical porting shown can be used for downward dispensing applications, such as sub-floors. Vertical upward porting could be used for upward dispensing, such as for ceilings or over-head applications.

The soft back pack can be stored in a stand-up position, if desired. In this embodiment, the rear and bottom of the back pack are reinforced and stable enough to allow the back pack to stand upright without tipping when it is removed from the operator's back. The sides of the back pack might also be reinforced so that the back pack could be tipped and supported on the side opposite the discharge port. In that position, the adhesive will not flow out due to gravity during attachment of the dispensing assembly. The back pack can optionally have wheels and a retractable handle, similar to a suitcase. The back pack can also optionally have a bracket to support the dispensing assembly when it is being stored.

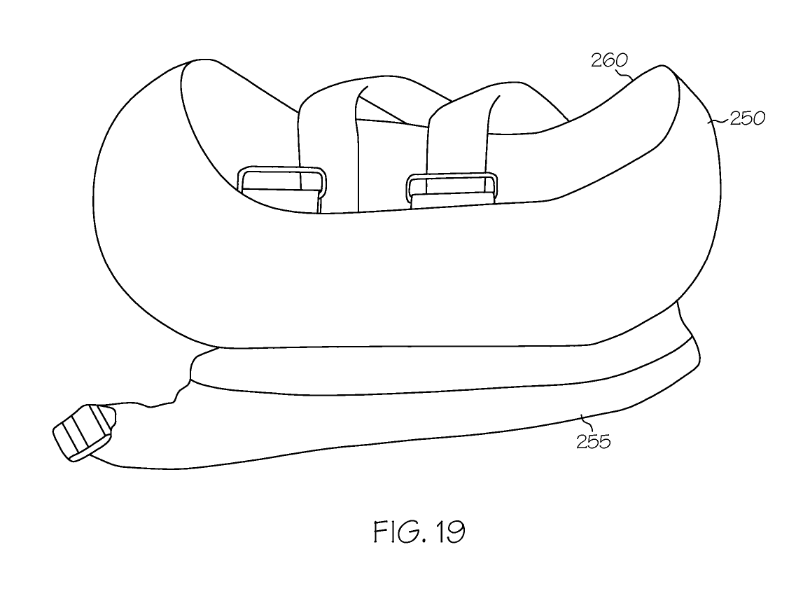

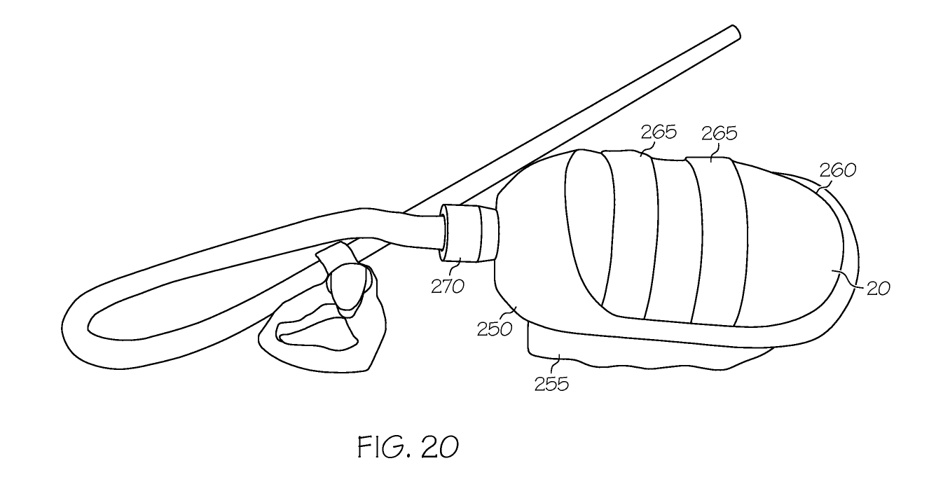

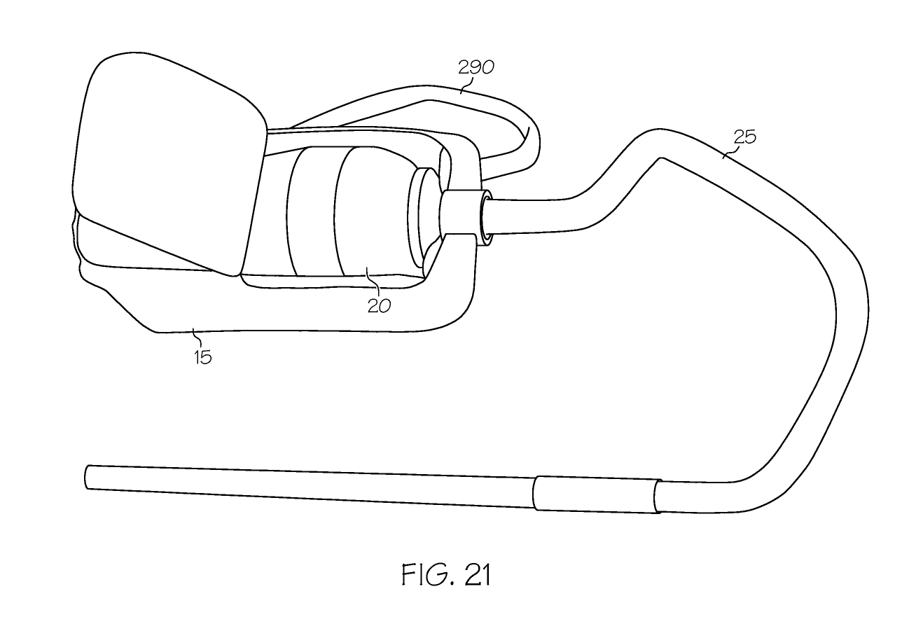

FIGS. 19 and 20 show an alternative embodiment of the carrying case, a hard back pack 15. FIG. 19 shows an empty back pack having a molded or formed holder 250 attached to an ergonomic back brace 255. The holder 250 is attached to the back brace 255 such that the position of the holder can be adjusted. Thus, the back brace 255 would be mounted on the back of the operator, in a standard ergonomic position, but the holder 250 could be attached in the vertical or horizontal position. This would allow the fluid container 20 and the dispensing assembly 25 to be positioned optimally and ergonomically for any type of dispensing application. The holder 250 can be attached to the back brace 255 using straps or fasteners so that it is nested or locked in place on the back brace. Alternatively, the holder 250 can be attached permanently to the back brace 255, and the back brace could have adjustable positions. The shoulder straps and waist belt could be attached at various positions on the back brace. They can be located so that the back brace conforms to the lumbar of the back for ergonomic reasons. The back brace can include padding and semi- rigid materials that allow it to conform ergonomically. The holder can be made of plastic or metal to protect the fluid dispenser from damage during use or handling.

FIG. 20 shows the fluid container 20 inserted into the holder 250. There is an opening 260 for access to the fluid container 20. Straps 265 hold the fluid container 20 in the holder 250. The fluid container 20 has a vertical port and a straight connector 270 that extends through a separate hole at the bottom of the holder 250, although other types of connectors could be used. However, the side and bottom openings could be arranged such that the fluid holder 20 and dispensing assembly 25 could be inserted and removed while connected. The straps 265 could include a padded flap for viewing the contents of the fluid container 20, if desired. The padded flap would help to protect the fluid container 20 during use and handling.

FIG. 21 shows one embodiment of a shoulder pack style carrying case 15. The shoulder pack 15 is generally designed for fluid containers holding less than about 15 lbs. As with the back pack, the shoulder pack can be made of soft flexible material, semi-rigid material, or a hard material. The ergonomic benefits of the shoulder pack 15 include the comfortable support and bracing of medium sized loads on the operator's shoulder and hip, and the improvement in the posture and position of the operator when performing the work (i.e., standing instead of kneeling), which reduces leg and back pain from squatting and bending. The shoulder pack 15 makes it easy for the operator to replace the consumable fluid container 20. In addition, the operator can position the output of the fluid container so that the dispensing assembly is optimum for the dispensing application. The shoulder pack is also lightweight and durable.

The shoulder pack can carry up to about 15 lbs. of adhesive. A soft shoulder pack weighs about 3 lbs. (a hard shoulder pack will weigh slightly more), which provides an adhesive to holder ratio of about 5 to 1. The shoulder pack 15 has ergonomic shoulder and belt straps that are designed to make the shoulder pack supportive and comfortable to wear. The shoulder pack's 15 lb. capacity will have to be replaced 1/7 as often as the cartridge hand gun. Because the shoulder pack holds less adhesive and weighs less, it may have an advantage if the application consumes adhesive over a longer period of time or requires the operator to have a lower center of balance while climbing on ladders during the application. The sealing of ductwork in HVAC applications is an example of a good use of a shoulder pack.

The shoulder pack 15 is supported on the side of the operator with a shoulder strap 290 and a belt strap (not shown). The operator has one hand free during a dispensing application, and the center of balance is lower on the operator's body. The dispensing assembly 25 is ported out the side (or lengthwise end) of the housing. Side porting can be advantageous because it locates the dispenser port at the mid-height of the operator. This enables the operator to reach up and down easily with the shortest length of dispensing tube during the application. This configuration is desirable for applying adhesive on dry wall or applications where it is necessary to climb ladders. It is also easier to remove the dispenser quickly for safety reasons.

The top loading shoulder pack is easy to load with the fluid container 20. The fluid container 20 can be removed with the dispensing assembly 25 attached.

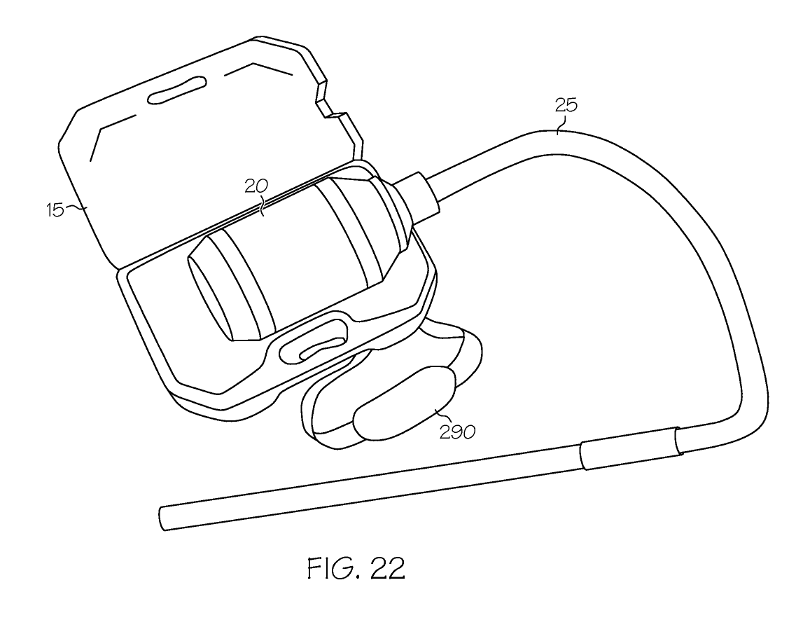

One embodiment of a semi-rigid shoulder pack is shown in FIG. 22. The shoulder pack is made of a durable molded plastic housing. The shoulder pack is supported on the side of the operator with both a shoulder strap 290 and a belt strap (not shown). The shoulder pack 15 has side porting for the dispensing assembly. The shoulder strap 290 supports the weight of the shoulder pack along with the belt strap. The belt strap also helps keep the shoulder pack from swinging freely when the operator moves around. The molded housing has a living hinge on the vertical access which allows it to be opened from the side as shown. The input energy/drive system, such as pneumatic components, can be conveniently mounted on the front of the housing. The molded housing could have a living hinge on the horizontal access that would allow it to be opened from the top, if desired. Alternatively, the molded housing could have a slotted opening along the lengthwise side. The fluid container 20, with or without the dispensing assembly 25, could be loaded easily and the opening covered with a flap.

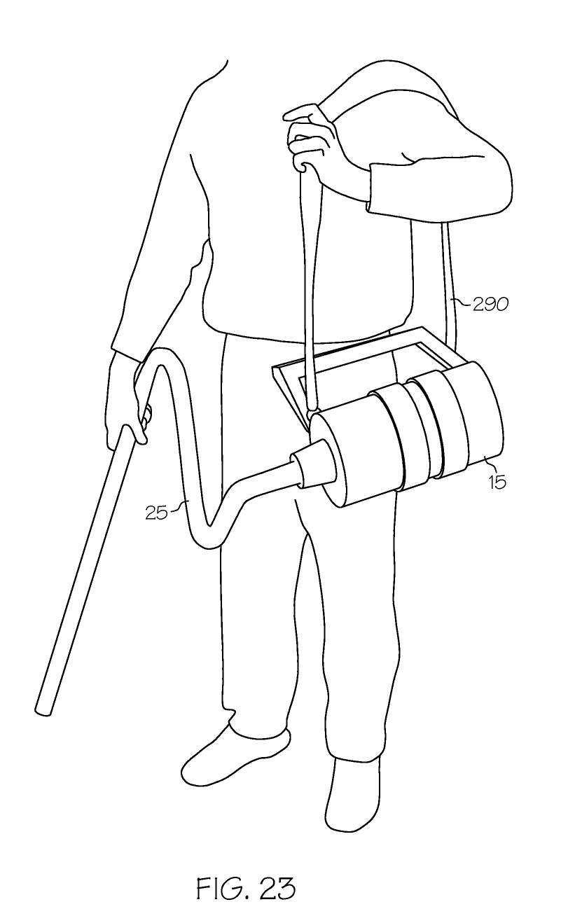

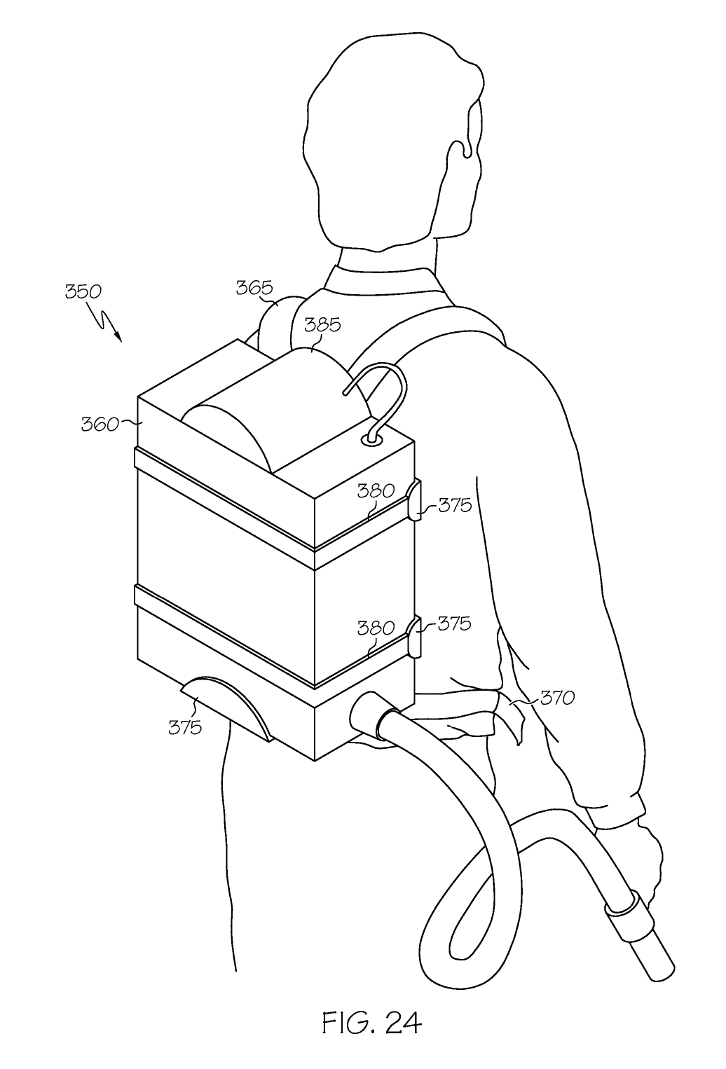

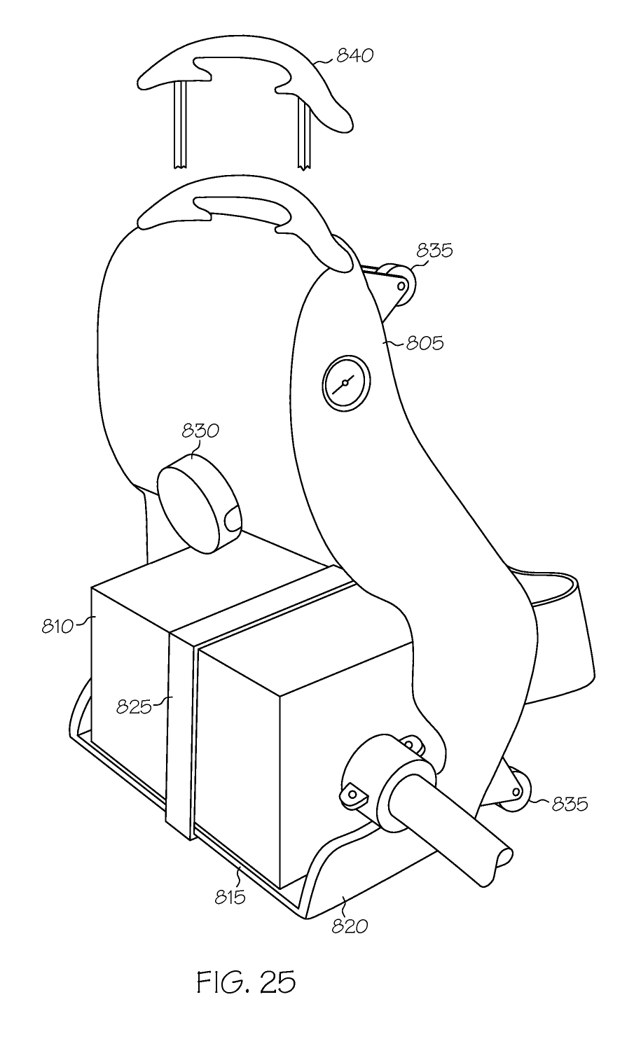

One embodiment of a hard shoulder pack 15 is shown in FIG. 23. It has a formed metal housing for holding the fluid container. The hard shoulder pack is supported at the side of the operator with shoulder strap 290 and belt strap (not shown). This embodiment has side porting of the dispensing assembly 25. The metal housing has a round shape similar to the fluid container, and can include cushioning on the inside to protect the fluid container 20 in case it is dropped. The housing can have a hinged rear cover that allows the fluid container 20 to be inserted from the rear. The input energy/drive system, such as pneumatic controls, can be conveniently mounted on the hinged rear cover of the housing. This type of hard shoulder pack is slightly heavier than the other styles. Therefore, the shoulder strap could be double and supported by both shoulders (similar to a golf bag), if desired.

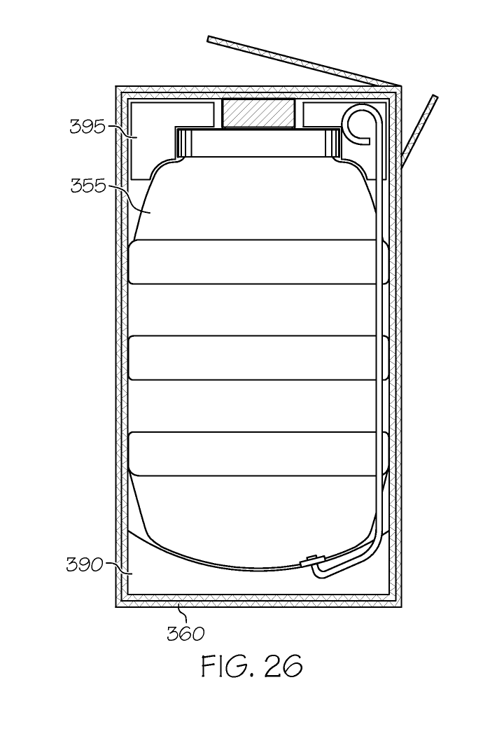

FIGS. 24-26 show another embodiment of a back pack 350. These arrangements involve a more open design that may be easier to maintain. Fluid container 355 is enclosed in carton or box 360, such as a cardboard carton or box. Carton 360 provides protection for the fluid container 355. The carton 360 can stay with the fluid container 355 throughout its useful life, and protect the fluid container 355 from scratching, mis-handling, or other damage during filling, handling, and use.

As a consumable in the open style design, the package may be more presentable and visible to the users. Any labels applied to the carton will remain clean because the carton can be replaced when the bottle is changed. There is less structure and fabric which could become dirty, frayed, or destroyed during use. Therefore, it may be more durable and protected against damage than other types of back packs. This embodiment may be easier and less costly to clean should adhesive spill when the carton is being replaced with a new, filled carton.

Because the carton 360 is a consumable, any labels on the carton will always be clean and visible to the users. Unlike some other types of back packs or shoulder packs, the labels will not be covered by the back pack. It will be easier to provide printing and labeling on the carton 360 than it would be on the fluid container 355.

The open style design makes it easier for the operator to replace the consumable package. The operator can more easily position the output of the fluid container so that the dispensing assembly is optimum for the dispensing application.

The embodiment shown in FIG. 24 has a simple skeletal structure that holds the input energy/drive system along with an exposed carton that contains the fluid container. The carton is supported by the structure and held in place by straps, or the like. The back pack 350 includes shoulder straps 365 and a waist belt 370. The shoulder straps 365 and waist belt 370 are connected to supports 375. Supports 375 are connected to straps 380 which secure the carton 360 to the back pack. There is a compartment 385 to hold the input energy/drive system.

The embodiment shown in FIG. 25 has a support structure 805 for the carton 810. The support structure 805 includes a carton support 815 which includes side supports 820. The side supports 820 help to keep the carton 810 from slipping out of the support structure 805. The support structure 805 includes one or more straps 825 to hold the carton 810. The input energy/drive system 830 can be attached to the support structure 805. The support structure 805 can also include one or more wheels 835. The wheels 835 can be positioned at the bottom of the support structure 805, so that the support structure 805 can be maintained upright. Alternatively, the wheels 835 can be positioned on the bottom and the back or side of the support structure 805 so that the support structure 805 can be placed horizontally on the ground. The support structure 805 can also include a retractable and/or pivoting handle 840. The handle 840 allows the user to control and move the support structure or back pack while it is on the ground. The support structure may also include shoulder straps and an optional waist belt (not shown), if the support structure is to be placed on the operator's back for use. The support structure or back pack may be used either when it is on the back of the user or when it is on the floor.

The carton can be the packaging in which the fluid container is shipped. The carton can act as an external reinforcement of the fluid container while it is under air pressure. If the carton is designed as a complete package integral with the fluid container's use, the storage and protection of the bottle could begin with the bottle supplier and be maintained through recycling, if desired. The carton could be designed to keep the bottle contained within the carton and to stay with the fluid container through all stages of use. The fluid container could be filled while remaining in the carton, if desired.

The carton could be reinforced around the sides and edges for increased burst strength and reinforcement of the bottle pressure. The carton could also contain supports 390 in the bottom for clearance around the air inlet and cushioning during handling. The top of the carton could have flap reinforcements 395 to capture the bottle inside the carton and provide stacking strength. The top of the carton can also protect the cap and neck of the bottle.

The carton could be perforated to allow pull-tabs to be opened to expose the air inlet or the neck of bottle for attaching to the dispensing assembly. A pull-tab could also be provided for inspection of the contents of the bottle.

The carton could make it easier to orient and stabilize the bottle in the back pack, particularly if there were instructions indicating a preferred position for improved flow or an interchangeable side for right- or left-handed operators, for example.

The presence of the carton could make recycling of the bottle easier because it would minimize labels on the bottle. The carton could include instructions of various types, such as construction code information and recycling directions. The carton could also be used to ship the bottle to a recycler, if desired.

The carton is shown as being rectangular, which would be a typical shape due to ease of manufacture. However, other shapes could be used for the carton which would provide similar benefits, as recognized by those of skill in the art. Other shapes include, but are not limited to, a round or polygon shaped tube.

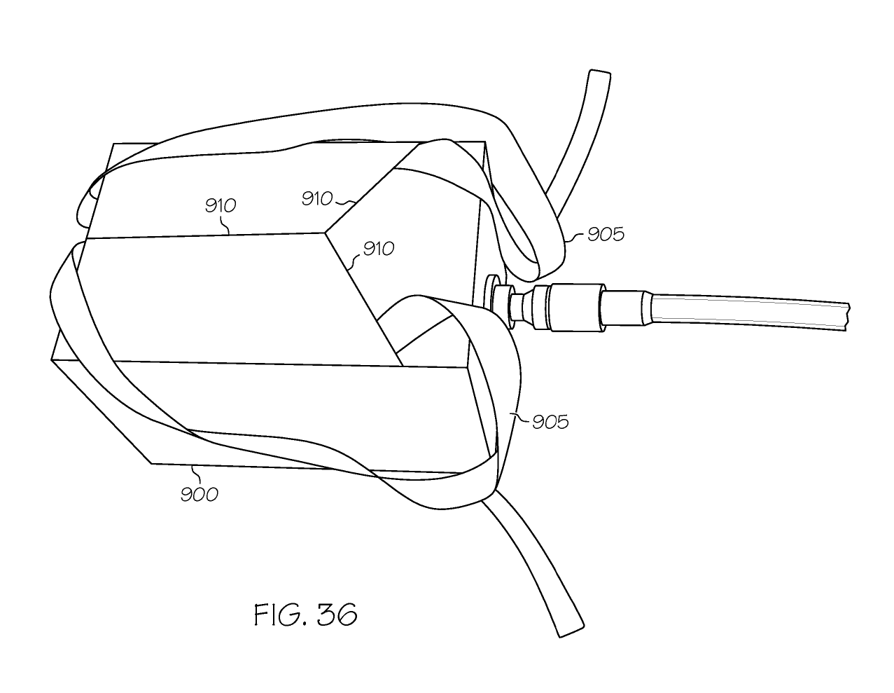

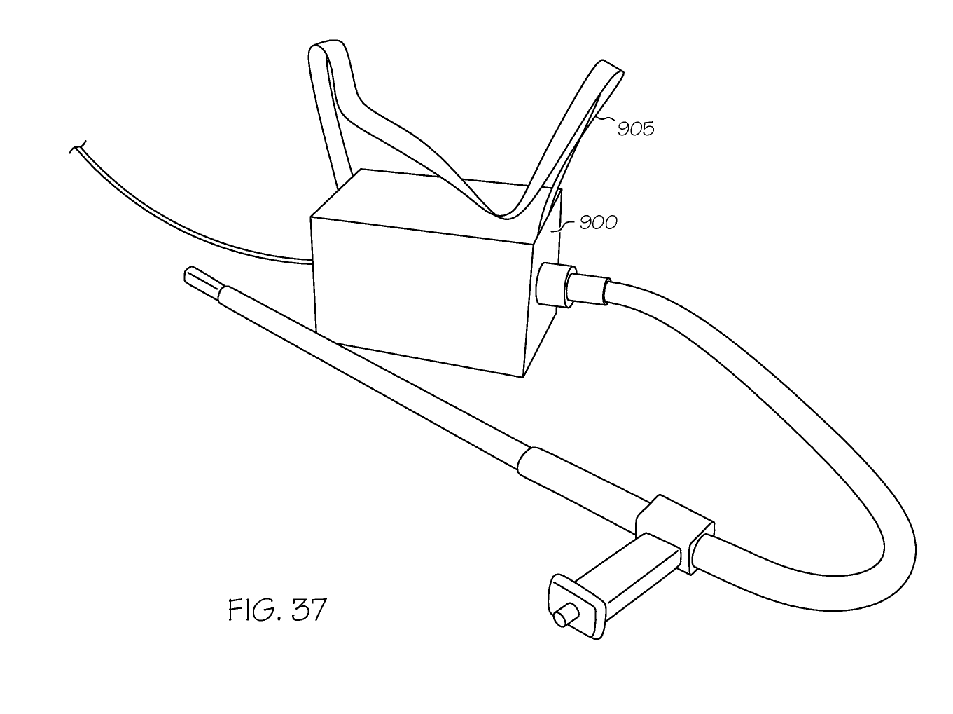

In another embodiment, there is no carrying case. The fluid container or the carton containing the fluid container is attached to the user's back or shoulder using appropriate ergonomic straps. Straps can be attached to the fluid container itself, with or without a carton, or to a carton containing the fluid container. FIGS. 36-37 show a carton 900 with straps 905. FIG. 36 shows two straps 905 so that the carton 900 can be positioned on the user's back, while FIG. 37 shows one strap 905 so that the carton 900 can be positioned on the user's side. The straps can be made of a low cost, flexible material. Inexpensive foam can be included on the straps or the carton for additional comfort, if desired. In some cases, the cost of the strap(s), and foam will be so low that they can be disposable. They can be included with the carton, which can be thrown away when the fluid has been dispensed. The materials can be selected to be degradable or recyclable, if desired.

The straps 905 can be included in the carton 900 during shipping, if desired. The carton 900 can include perforations 910 which allow part of the straps 905 to be removed from inside the carton for use.

The bottle can remain inside the carton during usage, if desired. The bottle and carton (if used) can be oriented vertically or horizontally and the port can be upward, downward, to the right or to the left, depending on the application. The shape of the carton can be designed to aid with the ergonomics. For example, if the bottle is to be oriented horizontally, a pentagonal, hexagonal, heptagonal, or octagonal carton may be more comfortable than a square or rectangular carton.

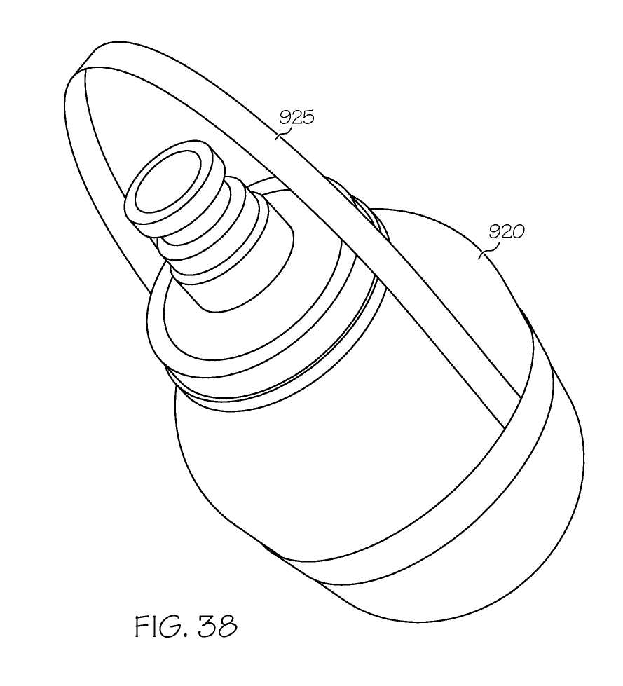

FIG. 38 shows one strap 925 attached directly to the bottle 920. The bottle can be used with or without a carton.

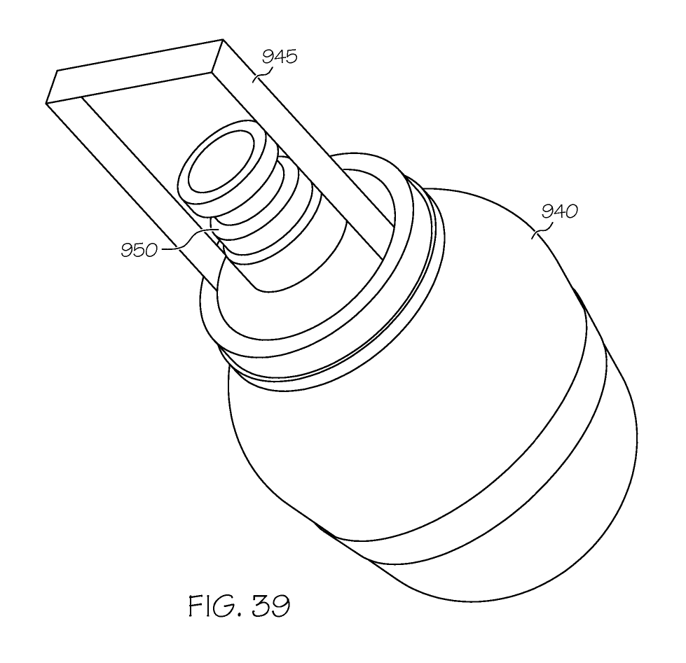

Alternatively, there could be a flexible or rigid handle attached to the bottle, as shown in FIG. 39. This arrangement would typically be used for smaller bottles, for example, one containing less than about 10 lbs. of adhesive. With less weight, the user could hold the bottle 940 in one hand and the dispensing assembly in the other. The handle 945 could be attached to the bottle at the top or on the side. It could be part of a bottle top 950, as shown, if desired. A fluid outlet could be formed in the bottle top and the dispensing assembly could be attached to it. The handle could be attached permanently to the bottle or it could be removable. In this embodiment, the components can all be disposable, if desired, making it a low-cost, easy to use system.

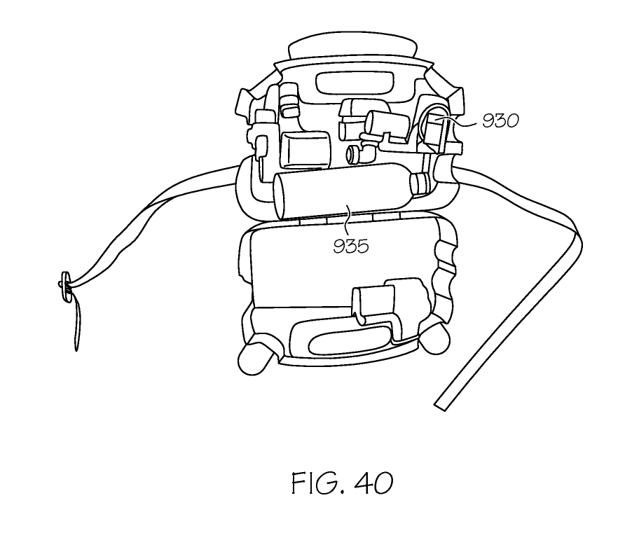

The energy input/drive system and/or controls can be placed in, or on, a waistpack or tool belt, if desired. In this arrangement, the energy input/drive system and/or controls are connected to the bottle by a short hose. FIG. 40 shows one embodiment of a waistpack 930 with electro-pneumatic controls 935.

Alternatively, there could be a remote air supply. There could be an air shut-off device attached to the air line before it connects to the bottle. The air line could be attached to an existing pneumatic supply at a construction site, for example. It could have a separate pressure regulator so that the maximum allowable air pressure could be set. It could also have a special fitment that would prevent the use of standard high pressure air lines.

The cost of the fluid dispenser is reduced by eliminating the carrying case. There will be some additional packaging costs if the straps are disposable, but this should be minimal.

The weight that is carried on the back or shoulder of the user is reduced by removing the carrying case. The weight can be further reduced by moving the input energy/drive system from the carrying case to a waistpack or tool belt, or by using a remote air supply.

There may be some sacrifice is comfort by eliminating the carrying case, but it should be offset by the reduced weight and/or shaping of the carton design.

The center of balance of the user will be improved by eliminating the carrying case and relocating the weight of the input energy/drive device from the back or shoulder to the waistpack/toolbelt or using a remote air supply.

The ergonomics and safety for the user are improved because the user can disengage the straps and remove the fluid container more quickly compared to the backpack carrying case. The ergonomics will also be improved because only the fluid container (and optional carton) will have to be placed on the user's back or shoulder. There is no need to change the bottle in the carrying case because it will be disposed of when empty.

The durability of the input energy/drive device will be improved because it will not be handled as much as when it was in the carrying case. Only the fluid container will be continuously handled (i.e., taken on and off the user's back or shoulder) during application of the fluid. If the fluid container is slightly damaged, but can still be used, it may not matter because the fluid container can be disposable after emptying, if desired.

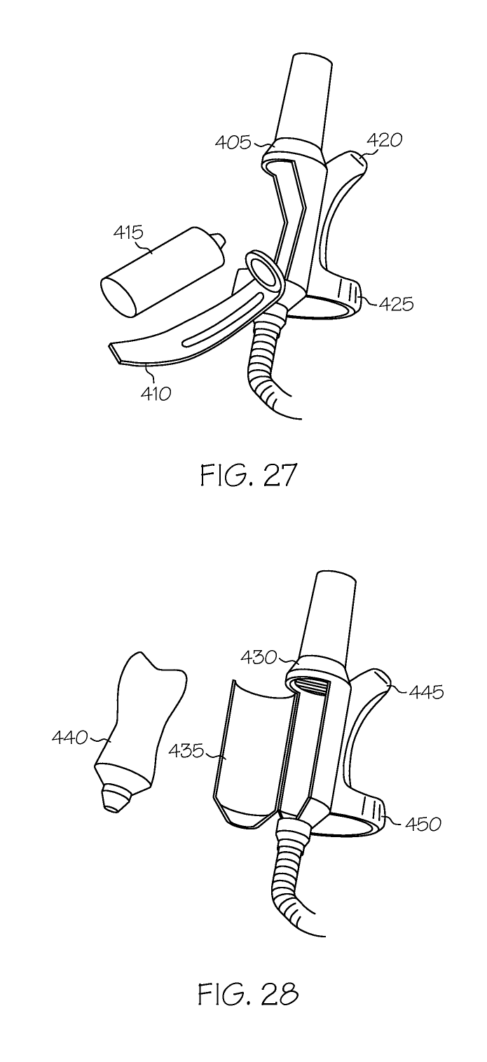

FIG. 27 shows another embodiment of a back pack style carrying case 405. The back pack has a door 410 hinged at the bottom to allow the fluid container 415 to be installed. The back pack also has a shoulder straps 420 and waist straps 425.

FIG. 28 shows another embodiment of a back pack style carrying case 430. The back pack has a door 435 hinged on the side to allow the fluid container 440 to be installed. The back pack also has a shoulder straps 445 and waist straps 450.

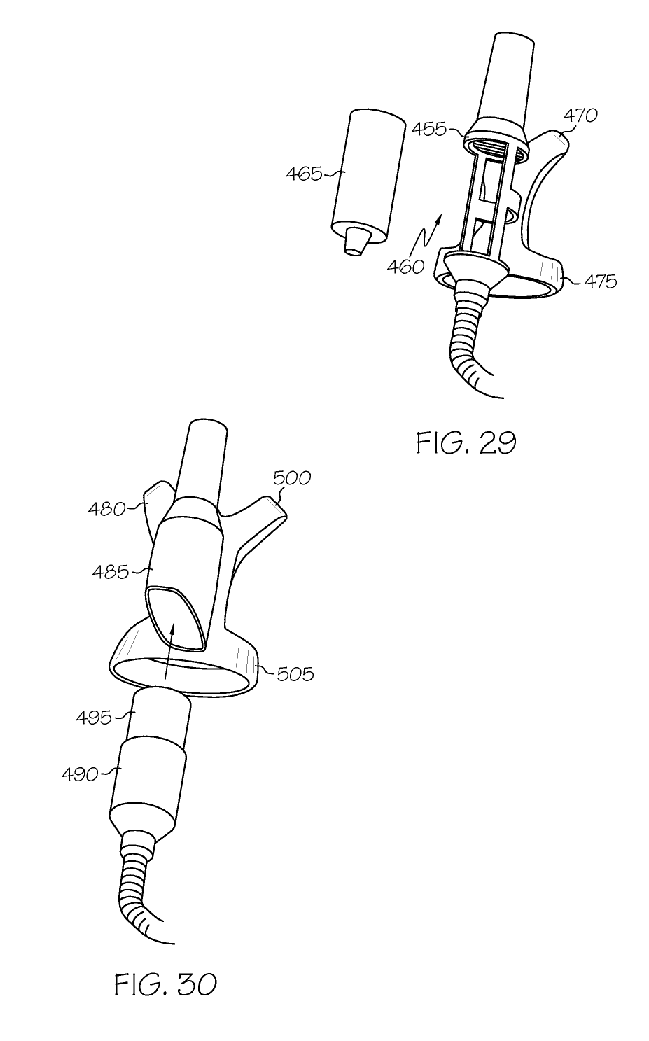

FIG. 29 shows another embodiment of a back pack style carrying case 455. The back pack is a frame having an opening 460 to allow the fluid container 465 to be installed. The back pack also has a shoulder straps 470 and waist straps 475.

FIG. 30 shows another embodiment of a back pack style carrying case 480. The back pack has an upper portion 485 and a lower portion 490 which can be separated allow the fluid container 495 to be installed. The back pack also has a shoulder straps 500 and waist straps 505.

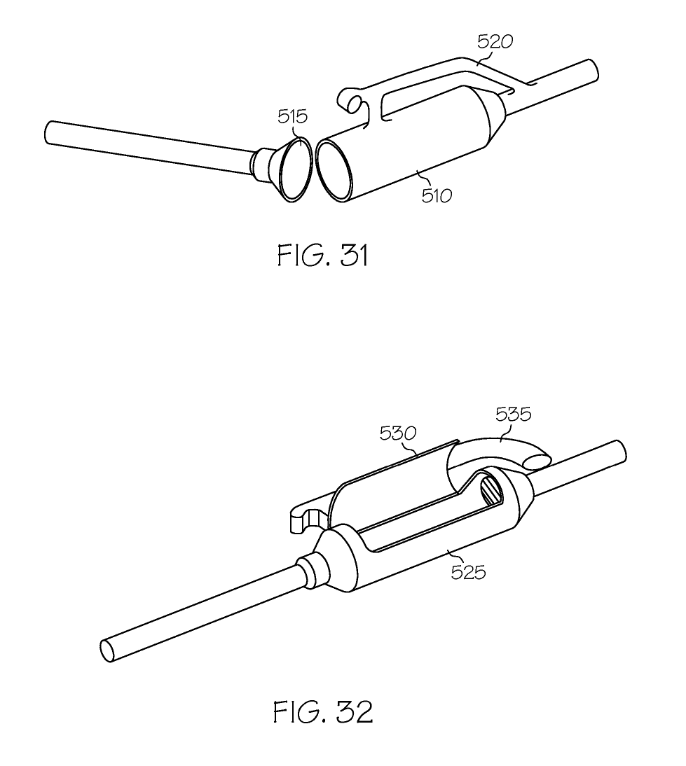

FIG. 31 shows another embodiment of a shoulder pack style carrying case 510. The bottom 515 of the shoulder pack is hinged to allow the fluid container to be installed. The shoulder pack 510 can include an optional handle 520 which allows additional control over the shoulder pack.

FIG. 32 shows another embodiment of a shoulder pack style carrying case 525. The shoulder pack has a door 530 hinged on the side to allow the fluid container to be installed. The shoulder pack 525 can include an optional handle 535 which allows additional control over the shoulder pack during use.

Alternatively, in FIGS. 27, 28, and 30-32, the fluid container could be a flexible bag. The carrying case could act as an air pressure chamber with the doors or upper and lower portions having a hermetic seal to prevent air leakage. There could be an optional piston which pushes on the end of the flexible bag, causing the adhesive to be dispensed.

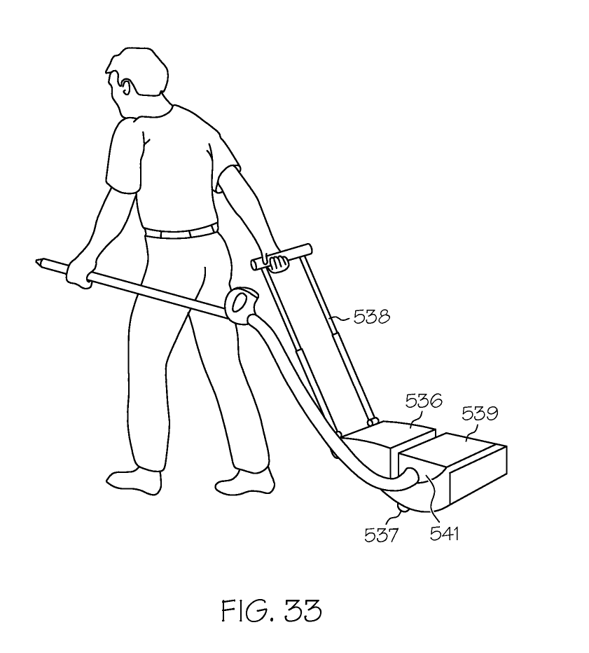

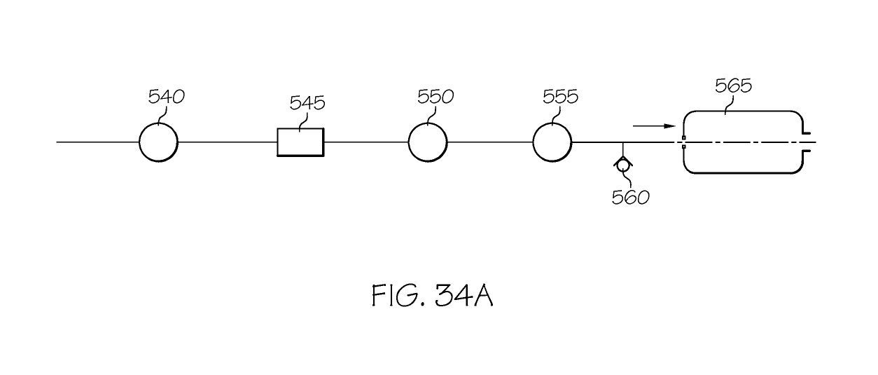

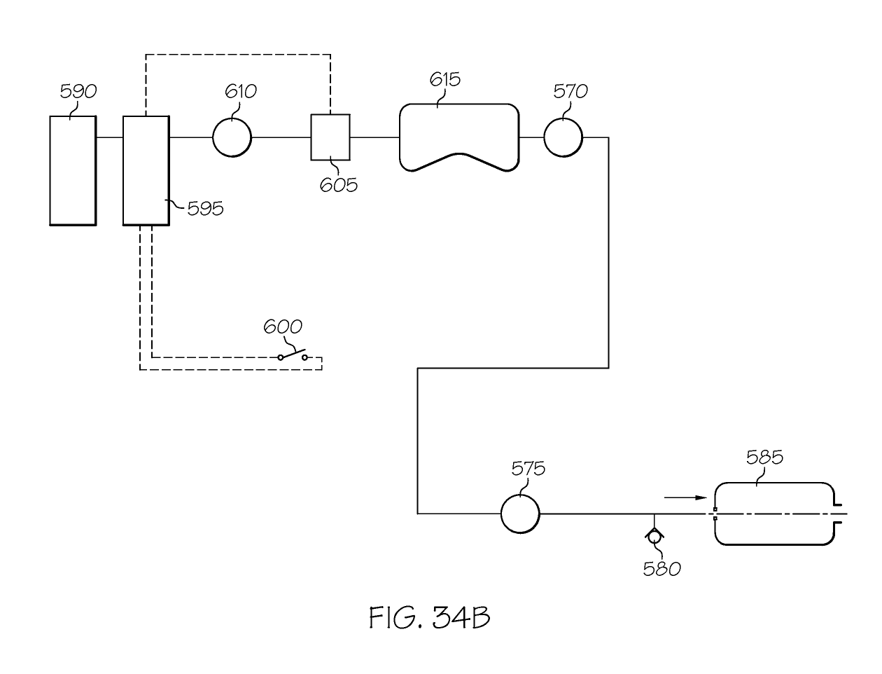

FIG. 33 shows one embodiment of the floor unit carrying case 536. The floor unit carrying case 536 can include wheels 537 so that it can be easily moved from one place to another. It can also have a handle 538 which allows the operator to control the movement. The fluid container 539 can be placed on the floor unit carrying case and secured in the compartment 541.

In some applications where the adhesive is to be applied to the ceiling or other overhead areas, the carrying case can be attached to a ladder, a scissors lift, a movable vertical stand, or other suitable stand, rather than being placed on the back of the user or the floor. The carrying case can include a clip or other attachment for this purpose. The fluid container is thus closer to the level of the application. This minimizes the hydraulic pressure head and pressure that would be required to pump the fluid from a floor position through the dispensing assembly.

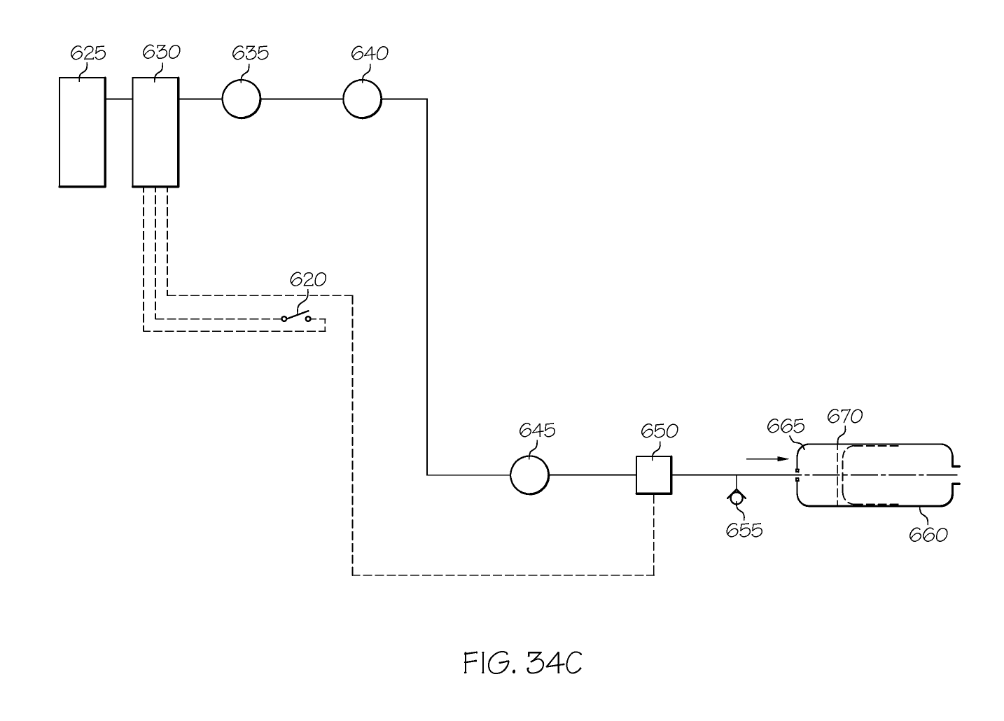

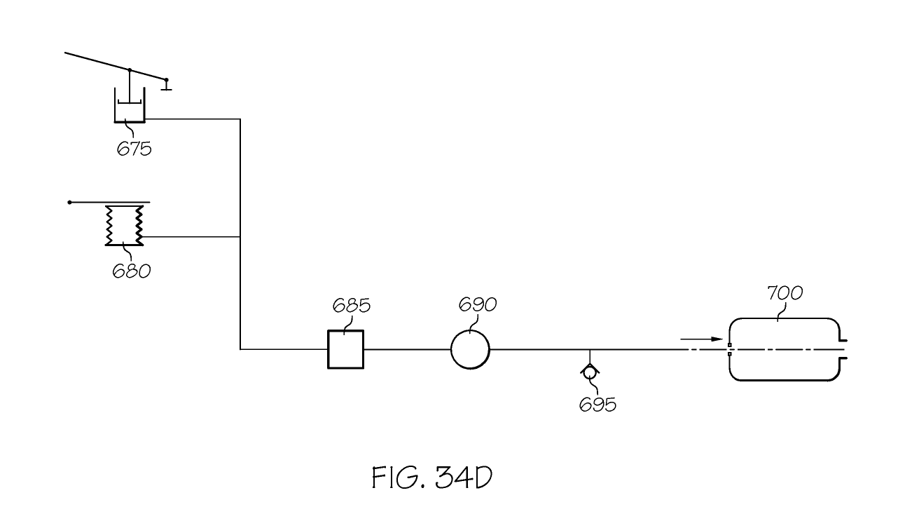

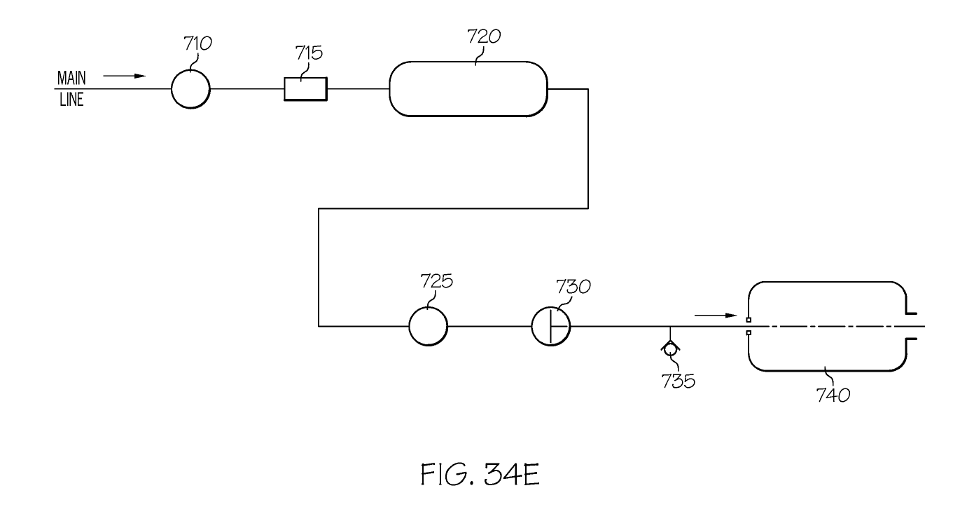

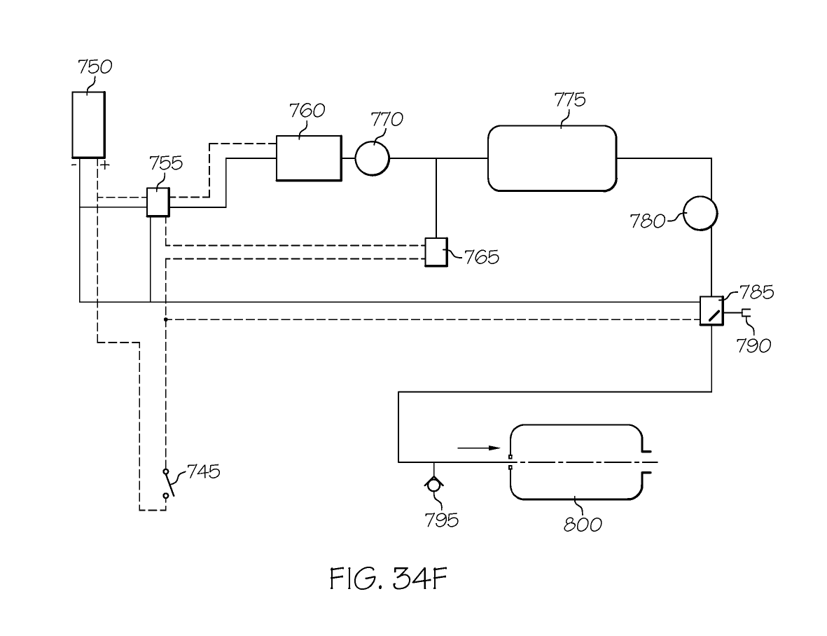

Various embodiments of the input energy/drive system of the present invention are shown in FIG. 34. The input energy/drive system uses various devices, such as pneumatic devices, for controlling pressurized air and powering the actuator diaphragm/bladder, which pushes the adhesive out of the fluid container and through the dispensing assembly. The input energy/drive system allows for minimum weight of drive hardware used in an ergonomic dispenser, while obtaining the power drive needed for dispensing the adhesive.

FIG. 34a shows the use of a main airline as the input to a pneumatic system. It can include, but is not limited to, a main pressure regulator 540, a shut-off valve 545, a low pressure regulator 550, a three-way shut-off valve 555 and an air pressure check valve 560. These devices control the air supply to the fluid container 565. This is the least costly and easiest way to configure the dispenser with a lightweight air supply system. A remote air supply is needed, but this is usually available on a construction site. An air hose is also needed, and this could inhibit the ergonomics.

FIG. 34b shows the use of a battery powered air pump as the input to a pneumatic system. It includes, but is not limited to, a pressure regulator 570, a three-way shut-off valve 575, and a check valve 580 for controlling the air supply to the fluid container 585. At the pneumatic input, it also includes a battery 590, electric controls 595, an on-off switch 600, and a pressure switch 605, which control an air pump 610 that supplies air to an accumulator 615 that stores an air supply. The accumulator 615 can be a flexible bladder or semi-rigid container built into the fluid dispenser. The accumulator 615 acts as a buffer between the air pump and the fluid container by storing a volume of air at a relatively constant pressure that is supplied on demand from the air pump 610, which cycles only when needed.

FIG. 34c is similar to FIG. 34b except that the accumulator is built into the bottom of the fluid container. At the pneumatic input, the system includes, but is not limited to, an on-off switch 620, a battery 625, and electric controls 630, which control an air pump 635 that supplies air to the accumulator. The system can also include, but is not limited to, a pressure regulator 640, a shut-off valve 645, a pressure switch 650, and a check valve 655 for controlling the air supply to the fluid container 660. The accumulator 665 is included in the fluid container 660. A false bottom 670 is placed inside the fluid container 660 at the entry side. This ensures that even when the fluid container 660 is full of adhesive, there will be a small volume of air that is accumulated or stored. This small volume also acts as a buffer for the air pump to help maintain a constant pressure as the air pump cycles and volume in the fluid container varies as the adhesive discharges. The maximum flow rate will be approximately 10 cc/sec, and the flow rate will vary depending on the changes in the viscosity of the adhesive, which then affects the frictional pressure drop across the discharge. Although the volume of discharge may vary, the pneumatic system will be more stable if the input pressure is relatively constant and controlled.

FIG. 34d shows the use of manual pumps to generate the air pressure needed to move the diaphragm/bladder, which pushes the adhesive out of the fluid container. The system includes, but is not limited to, a hand/arm pump 675 and/or a foot/leg pump 680, a check valve 685, a shut-off valve 690, and a check valve 695 to control the air supply to the fluid container 700. The pneumatic system for the high viscosity adhesive generally uses a low pressure of approximately 15 psi gage pressure, which equates to about 30 psi absolute pressure, or 2 atmospheres, inside the bottle as compared to 15 psi absolute, or 1 atmosphere, outside the bottle. As such, the manual pump has to compress twice the volume of air outside the bottle down to the volume consumed inside the bottle. This would require a large amount of manual work for the continuous high flow rate (10 g/sec or 10 cc/sec) applications, such as sub-floors and dry wall. This might cause an ergonomic problem because of the repetitive motion of the manual pumping. However, for the intermittent low flow rate applications, such as HVAC duct sealing and other types of applications, less work and less repetitive motion would be required during manual pumping. In these applications, air pressure could be provided with a hand/arm pump if the application requires the operator to be mobile, or with a foot/leg pump if the application allows the operator to be stationary while pumping.

FIG. 34e shows the use of a high pressure accumulator 720. The system includes a main pressure regulator 710, a shut-off valve 715, and a high pressure accumulator 720. After the high pressure accumulator 720, there is a low pressure regulator 725, a shut-off valve 730 and an air pressure check valve 735. These devices control the air supply to the fluid container 740. This system can be detached from the main air line either before or after the main pressure regulator 710. It allows the user to be independent of an air supply hose during operation. The system will operate from the high pressure accumulator 720 during use. When the fluid container 740 is changed or refilled, the system can be reattached to the main air line to re-pressurize the high pressure accumulator 720.

FIG. 34f also shows the use of a high pressure accumulator 775. At the pneumatic input, it includes an on-off switch 745, a battery 750, a relay 750, an electric motor 760, and a pressure switch 765, which control an air pump 770 that supplies air to the high pressure accumulator 775. The system also includes, but is not limited to, a low pressure regulator 780, a shut-off valve 785, an exhaust and external air line input 790, and a check valve 795 for controlling the air supply to the fluid container 800. The shut-off valve 785 turns off the pressure to the fluid container 800 when the on-off switch 745 is on, and turns off the pressure from the fluid container when the on-off switch 745 is off. The high pressure air can be about 40 psi, while the low pressure air is up to about 20 psi.

The input energy/drive system could be designed to utilize a relatively constant air pressure with a fixed orifice volume for flow and a shut-off valve to stop flow. The flow could be varied by adjusting the pressure regulator. Alternatively, the controls could allow for variable fluid flow and/or variable air pressure. The controls could allow for a higher pressure input condition that varies as the adhesive is dispensed, but is compensated for controlling the flow rate. This could be accomplished by a combined valve or two separate valves that the operator would actuate to vary the flow volume and to turn on and shut off the flow. The combined valve could be located on the end of the dispensing assembly, if desired. Separate valves could have the flow volume adjustment anywhere on the dispensing assembly, but still have the shut-off valve at the end of the assembly to prevent dripping.

FIG. 35 shows various types of devices attached integrally with the fluid container to limit the internal pressure. FIG. 35a shows a pneumatic pressure check valve that is integral with the air inlet fitting. FIG. 35b shows a pneumatic pressure disk, built into the fitting, which is designed to pop out at a maximum pressure. FIG. 35c shows a bladder puncture point built in to the exit port, which ruptures the bladder when the bottle is empty. FIG. 35d shows a hydraulic pressure check valve built into the neck or equivalent of the fluid container at the exit port. FIG. 35e shows a hydraulic pressure check valve built into the fitment or coupling of the dispensing assembly.

While certain representative embodiments and details have been shown for purposes of illustrating the invention, it will be apparent to those skilled in the art that various changes in the apparatus and methods disclosed herein may be made without departing from the scope of the invention.

What is claimed is:

1. An ergonomic fluid dispenser comprising:
a fluid container having a fluid outlet, the fluid container holding about 5 pounds or more of a fluid, wherein in the fluid is a high viscosity fluid, a sticky fluid, a fluid which hardens, or combinations thereof;
a dispensing assembly to dispense the fluid, the dispensing assembly in fluid communication with the fluid outlet; and
at least one ergonomic strap or handle attached to the fluid container so that an operator may remain upright during application of the fluid.

2. The ergonomic fluid dispenser of claim 1 wherein there are two shoulder straps.

3. The ergonomic fluid dispenser of claim 1 further comprising a cardboard carton, the fluid container being positioned in the carton.

4. The ergonomic fluid dispenser of claim 3 wherein the carton has perforations so that a portion of the at least one strap can be removed from the carton for use.

5. The ergonomic fluid dispenser of claim 3 wherein the carton includes flap reinforcements.

6. The ergonomic fluid dispenser of claim 3 wherein the carton has a shape selected from square, rectangular, pentagonal, hexagonal, heptagonal, or octagonal.

7. The ergonomic fluid dispenser of claim 1 wherein the at least one strap further comprises at least one foam pad.

8. The ergonomic fluid dispenser of claim 1 further comprising an energy input/drive device operatively connected to the fluid container, the energy input/drive device positioned in or on a waistpack or toolbelt.

9. The ergonomic fluid dispenser of claim 1 wherein the fluid is selected from adhesives, sealants, caulks, or combinations thereof.

10. An ergonomic fluid dispenser comprising:
a fluid container having a fluid outlet, the fluid container holding about 5 pounds or more of a fluid, wherein in the fluid is a high viscosity fluid, a sticky fluid, a fluid which hardens, or combinations thereof;
a dispensing assembly to dispense the fluid, the dispensing assembly in fluid communication with the fluid outlet;
a carton, the fluid container being positioned in the carton; and
at least one ergonomic strap attached to the carton so that an operator may remain upright during application of the fluid.

11. The ergonomic fluid dispenser of claim 10 wherein there are two shoulder straps.

12. The ergonomic fluid dispenser of claim 10 wherein the carton has perforations so that a portion of the at least one strap can be removed from the carton for use.

13. The ergonomic fluid dispenser of claim 10 wherein the carton includes flap reinforcements.

14. The ergonomic fluid dispenser of claim 10 wherein the carton has a shape selected from square, rectangular, pentagonal, hexagonal, heptagonal, or octagonal.

15. The ergonomic fluid dispenser of claim 10 wherein the at least one strap further comprises at least one foam pad.

16. The ergonomic fluid dispenser of claim 10 further comprising an energy input/drive device operatively connected to the fluid container, the energy input/drive device positioned in or on a waistpack or toolbelt.

17. The ergonomic fluid dispenser of claim 10 wherein the fluid is selected from adhesives, sealants, caulks, or combinations thereof.

18. A method for dispensing a high viscosity fluid, comprising:
placing an ergonomic fluid dispenser on the back or shoulder of a user, the ergonomic fluid dispenser comprising:
a fluid container having a fluid outlet, the fluid container holding about 5 pounds or more of a fluid, wherein in the fluid is a high viscosity fluid, a sticky fluid, a fluid which hardens, or combinations thereof;
a dispensing assembly to dispense the fluid, the dispensing assembly in fluid communication with the fluid outlet;
an optional carton, the fluid container being positioned in the carton; and
at least one ergonomic strap attached to the fluid container or the optional carton so that an operator may remain upright during application of the fluid;
dispensing the high viscosity fluid through the dispensing assembly;
removing the ergonomic fluid dispenser from the back or shoulder of the user; and
disposing of the ergonomic fluid dispenser.

19. The method of claim 18 wherein the ergonomic fluid dispenser includes a carton, the carton having a perforation, and further comprising opening the perforation in the carton to remove the at least one strap from the carton.

20. The method of claim 19 wherein the ergonomic fluid dispenser further comprises an energy input/drive device operatively connected to the fluid container, and further comprising placing the energy input/drive device in or on a waistpack or toolbelt.

21. The ergonomic fluid dispenser of claim 1 wherein there is one shoulder strap.

22. The ergonomic fluid dispenser of claim 1 wherein there is a handle.

23. The ergonomic fluid dispenser of claim 22 wherein the handle is rigid.
